(19) United States
(12) Patent Application Publication
(10) Pub. No.: US 2012/0089995 A1
(43) Pub. Date: Apr. 12, 2012

(54) DISK APPARATUS

(76) Inventors: Takuto Yamazaki, Nara (JP); Yukio Morioka, Osaka (JP); Norikatsu Yoshida, Hyogo (JP); Yuji Ariyoshi, Osaka (JP); Shinichi Maeda, Osaka (JP); Hitoshi Higaki, Osaka (JP); Tatsuro Nishi, Osaka (JP)

(21) Appl. No.: 13/378,197

(22) PCT Filed: Mar. 29, 2011
(86) PCT No.: PCT/JP2011/001858

§ 371 Date: Dec. 14, 2011

(30) Foreign Application Priority Data
Mar. 30, 2010 (JP) 2010-078336

(51) Int. Cl. G11B 17/04

(52) U.S. Cl. 720/622; G9B/17.013

(57) ABSTRACT

A disk device of the invention is provided with a trigger member rotated by being contacted with and pressed by a disk having a different diameter to be conveyed to a replayable position, a slide cam member which drives a disk installment mechanism by being pressed and moved by the trigger member, and a centering member which centers the disk so that the disk faces a turntable at the replayable position. The trigger member has a rotation shaft portion serving as a rotation center, a disk contact portion to be contacted with the disk, and a pressing portion for pressing the slide cam member, and the centering member is provided movably in a disk conveying direction by being contacted with and pressed by the conveyed disk, and has a guide portion for moving the rotation shaft portion of the trigger member in accordance with movement in the disk conveying direction.

### TECHNICAL FIELD

The present invention relates to a slot-in type disk device in which a disk is directly inserted into a casing of the device without using a tray, particularly to a disk device for conveying a disk having a different diameter to a replayable position, and installing the disk conveyed to the replayable position onto a turntable so as to bring the disk into a replayable clamping state.

### BACKGROUND ART

Conventionally, this type of disk device is provided with a disk conveyance mechanism for conveying the disk inserted into the casing to the replayable position, and a disk installment mechanism for installing the disk conveyed to the replayable position onto the turntable so as to bring the disk into the replayable clamping state. The disk conveyance mechanism is for example provided with a rotatable lever provided so as to be contacted with the conveyed disk. The disk conveyance mechanism determines whether the disk is a large-diameter disk or a small-diameter disk in accordance with a position of the lever pressed and rotated by the disk, places the disk at the replayable position in accordance with the disk, and drives the disk installment mechanism by utilizing rotation of the lever. As a disk device having such a configuration, for example, there are devices disclosed in Patent Document 1 (Japanese Unexamined Patent Publication No. 2004-281054), Patent Document 2 (Japanese Unexamined Patent Publication No. 2007-80337), and Patent Document 3 (Japanese Unexamined Patent Publication No. 2000-113546).

### PATENT DOCUMENTS

Patent Document 1: Japanese Unexamined Patent Publication No. 2004-281054
Patent Document 2: Japanese Unexamined Patent Publication No. 2007-80337
Patent Document 3: Japanese Unexamined Patent Publication No. 2000-113546

### SUMMARY OF THE INVENTION

### Subjects to be Solved by the Invention

In recent years, electric appliances such as a disk device are required to further reduce cost and be smaller. Therefore, the number of parts is required to be reduced, and a structure is required to be simplified. Meanwhile, in the conventional disk devices as in Patent Documents 1 to 3, two operations of placing the disk at the replayable position in accordance with the diameter of the disk and driving the disk installment mechanism (bringing the disk installment mechanism into a drivable state) are performed by interlocking many (at least four or more) parts.

An object of the present invention is to solve the above conventional issue, and to provide a disk device capable of further reducing the number of parts.

### Means for Solving the Subjects

In order to achieve the foregoing object, the present invention is provided with the following arrangements.

The present invention is to provide a disk device, comprising:

a disk conveyance mechanism which conveys a disk having a different diameter to a replayable position, a disk installment mechanism which installs the disk conveyed to the replayable position onto a turntable so as to bring the disk into a replayable clamping state;

a trigger member which is rotated by being contacted with and pressed by the disk conveyed by the disk conveyance mechanism;

a slide cam member which drives the disk installment mechanism by being pressed and moved by the rotated trigger member; and

a centering member which centers the disk so that the disk faces the turntable at the replayable position, wherein

the trigger member has a rotation shaft portion serving as a rotation center of the trigger member, a disk contact portion to be contacted with the disk, and a pressing portion for pressing the slide cam member, and

the centering member is provided movably in a disk conveying direction by being contacted with and pressed by the conveyed disk, and the centering member has a guide portion for moving the rotation shaft portion of the trigger member in accordance with movement in the disk conveying direction.

### Effects of the Invention

According to the disk device of the present invention, the centering member is provided movably in the disk conveying direction, and the rotation shaft portion of the trigger member is moved in accordance with the movement of the centering member in the conveying direction. With this configuration, the two operations of placing the disk at the replayable position in accordance with the diameter of the disk and driving the disk installment mechanism can be performed by three members of the trigger member, the centering member, and the slide cam member. Therefore, the number of parts can be further reduced.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is a perspective outer appearance view showing a main body of a disk device according to a first embodiment of the present invention and a disk;

FIG. 2 is an exploded perspective view of the disk device of FIG. 1;

FIG. 3 is a top view showing attachment states of parts to be attached to a mechanical chassis;

FIG. 4 is a top view showing a state immediately after a large-diameter disk is inserted into the disk device of FIG. 1;

FIG. 5 is a top view showing a state that the large-diameter disk inserted into the disk device of FIG. 1 is being conveyed to a replayable position;

FIG. 6 is a top view showing a state that the large-diameter disk inserted into the disk device of FIG. 1 is already conveyed to the replayable position;

FIG. 7 is a top view showing an attachment state of a pair of roller arms and a pair of link arms;

FIG. 8A is a bottom view showing a state that the pair of roller arms is rotated in the direction in which the roller arms are brought close to each other;

FIG. 8B is a bottom view showing a state that the pair of roller arms is rotated in the direction in which the roller arms are brought away from each other;

FIG. 9 is an exploded perspective view showing a configuration of parts relating to an upper base;

FIG. 10 is a bottom view showing a state that the parts of FIG. 9 are attached to the upper base;

FIG. 11 is a top view showing a relative movement trajectory of a slide cam pressing portion of a trigger lever relative to engagement portions formed in a slide cam member at the time of inserting the large-diameter disk;

FIG. 12 is a top view showing a state that the large-diameter disk is contacted with a positioning contact portion of a centering member;

FIG. 13 is a top view showing a state that, from the state shown in FIG. 12, the trigger lever is pressed by the large-diameter disk and moved at right angle to the disk conveying direction;

FIG. 14 is a top view showing a state that, from the state shown in FIG. 13, the trigger lever is further rotated by being pressed by the large-diameter disk, and the slide cam pressing portion of the trigger lever is contacted with a second engagement portion of the slide cam member;

FIG. 15 is a top view showing a state that the large-diameter disk is already conveyed to the replayable position;

FIG. 16 is a top view showing a state that an installment operation of the large-diameter disk is completed;

FIG. 17 is a top view showing a relative movement trajectory of the slide cam pressing portion of the trigger lever relative to the engagement portions formed in the slide cam member at the time of inserting a small-diameter disk;

FIG. 18 is a top view showing a state that the small-diameter disk is contacted with the positioning contact portion of the centering member;

FIG. 19 is a top view showing a state that, from the state shown in FIG. 18, the centering member is pressed by the small-diameter disk and the small-diameter disk is contacted with an contact portion of the trigger lever;

FIG. 20 is a top view showing a state that the small-diameter disk is already conveyed to the replayable position;

FIG. 21 is a top view showing a state that an installment operation of the small-diameter disk is completed;

FIG. 22 is a view showing a positional relationship of the slide cam member, the centering member, and the trigger lever relative to the large-diameter disk conveyed to the replayable position, and a positional relationship of the slide cam member, the centering member, and the trigger lever relative to the small-diameter disk conveyed to the replayable position;

FIG. 23 is a perspective view of the slide cam member;

FIG. 24A is a perspective view showing a positional relationship between an intermediate chassis and a pair of slide cam members when a turntable is lowered;

FIG. 24B is another perspective view showing a positional relationship between the intermediate chassis and the pair of slide cam members when the turntable is lowered;

FIG. 25 is a top view showing a positional relationship between the pair of slide cam members and a link arm when the turntable is lowered;

FIG. 26A is a perspective view showing a positional relationship between the intermediate chassis and the pair of slide cam members when the turntable is raised;

FIG. 26B is another perspective view showing a positional relationship between the intermediate chassis and the pair of slide cam members when the turntable is raised;

FIG. 27 is a top view showing a positional relationship between the pair of slide cam members and the link arm when the turntable is raised;

FIG. 28 is a bottom view showing a positional relationship among the pair of slide cam members, the link arm, and a clutch plate when the turntable is lowered;

FIG. 29 is a bottom view showing a positional relationship among the pair of slide cam members, the link arm, and the clutch plate when the turntable is raised;

FIG. 30 is a perspective view of the clutch plate;

FIG. 31 is a top view showing a positional relationship of parts relating to the clutch plate before a disk conveyance operation;

FIG. 32 is a top view showing a positional relationship of the parts relating to the clutch plate during a disk installment operation;

FIG. 33 is a top view showing a positional relationship of the parts relating to the clutch plate after completion of the disk installment operation;

FIG. 34A is a perspective view of a configuration of a rack and a buffer rack of the slide cam member, showing a state that an auxiliary rack body in which the buffer rack is formed is biased by a spring;

FIG. 34B is a perspective view of the configuration of the rack and the buffer rack of the slide cam member, showing a state that the auxiliary rack body in which the buffer rack is formed moves against bias force of the spring;

FIG. 35 is a top view showing a state at an instant when the slide cam member slides, and a rack tooth of the buffer rack is contacted with a tooth of a pinion;

FIG. 36 is a top view showing a state at an instant when the auxiliary rack body moves against the bias force of the spring so that collision between the rack tooth of the buffer rack and the tooth of the pinion is absorbed;

FIG. 37 is a top view showing a state at an instant when the rack teeth of the buffer rack are meshed with the teeth of the pinion and the slide cam member starts sliding;

FIG. 38A is a perspective view showing a positional relationship between a disk insertion blocking member and the clutch plate when the disk insertion blocking member is lowered;

FIG. 38B is a perspective view showing a positional relationship between the disk insertion blocking member and the clutch plate when the disk insertion blocking member is raised; and

FIG. 39 is a bottom view showing a state that the parts relating to the upper base are attached to the upper base in a disk device according to a second embodiment of the present invention.

### MODE FOR CARRYING OUT THE INVENTION

According to a first aspect of the present invention, there is provided a disk device, comprising:

a disk conveyance mechanism which conveys a disk having a different diameter to a replayable position;

a disk installment mechanism which installs the disk conveyed to the replayable position onto a turntable so as to bring the disk into a replayable clamping state;

a trigger member which is rotated by being contacted with and pressed by the disk conveyed by the disk conveyance mechanism;

a slide cam member which drives the disk installment mechanism by being pressed and moved by the rotated trigger member; and

a centering member which centers the disk so that the disk faces the turntable at the replayable position, wherein

the trigger member has a rotation shaft portion serving as a rotation center of the trigger member, a disk contact portion to be contacted with the disk, and a pressing portion for pressing the slide cam member, and

the centering member is provided movably in a disk conveying direction by being contacted with and pressed by the conveyed disk, and the centering member has a guide portion for moving the rotation shaft portion of the trigger member in accordance with movement in the disk conveying direction.

According to a second aspect of the present invention, there is provided the disk device as defined in the first aspects, wherein the guide portion differentiates a position of the rotation shaft portion of the trigger member between a case where the disk is a small-diameter disk and a case where the disk is a large-diameter disk.

According to a third aspect of the present invention, there is provided the disk device as defined in the first or second aspect, wherein the guide portion does not move the rotation shaft portion of the trigger member in a case where the disk is the small-diameter disk, and the guide portion moves the rotation shaft portion of the trigger member in a case where the disk is the large-diameter disk.

According to a fourth aspect of the present invention, there is provided the disk device as defined in any one of the first to third aspects, wherein the guide portion has a first straight guide portion provided in parallel to the conveying direction so as to retain the rotation shaft portion of the trigger member at a first position, a tilt guide portion provided in a crossing direction to the conveying direction so as to move the rotation shaft portion of the trigger member from the first position to a second position with respect to the conveying direction, and a second straight guide portion provided in parallel to the conveying direction so as to retain the rotation shaft portion of the trigger member at the second position.

According to a fifth aspect of the present invention, there is provided the disk device as defined in any one of the first to fourth aspects, wherein the centering member has a pair of large-diameter disk positioning contact portions to be contacted with a large-diameter disk so as to center the large-diameter disk, and a pair of small-diameter disk positioning contact portions to be contacted with a small-diameter disk so as to center the small-diameter disk.

According to a sixth aspect of the present invention, there is provided the disk device as defined in any one of the first to fifth aspects, wherein the slide cam member has a first engagement portion to be engaged with the pressing portion of the trigger member when the disk contact portion of the trigger member is contacted with a small-diameter disk serving as the disk, and a second engagement portion to be engaged with the pressing portion of the trigger member when the disk contact portion of the trigger member is contacted with a large-diameter disk serving as the disk.

According to a seventh aspect of the present invention, there is provided the disk device as defined in the sixth aspect, wherein

the slide cam member has a cam portion for connecting the first engagement portion and the second engagement portion, and

the cam portion guides movement of the pressing portion of the trigger member from the first engagement portion to the second engagement portion when the large-diameter disk serving as the disk is conveyed and the rotation shaft portion of the trigger member moves.

Before describing the present invention, the same parts in the attached drawings are given the same reference symbols.

### First Embodiment

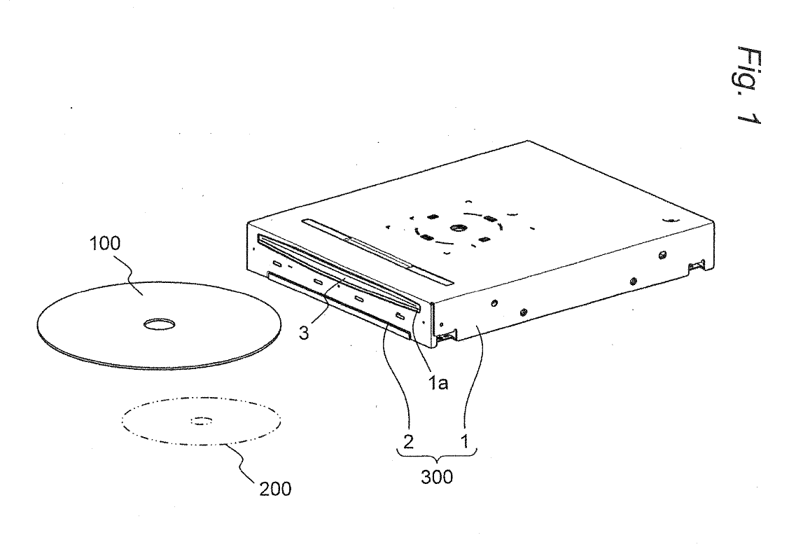

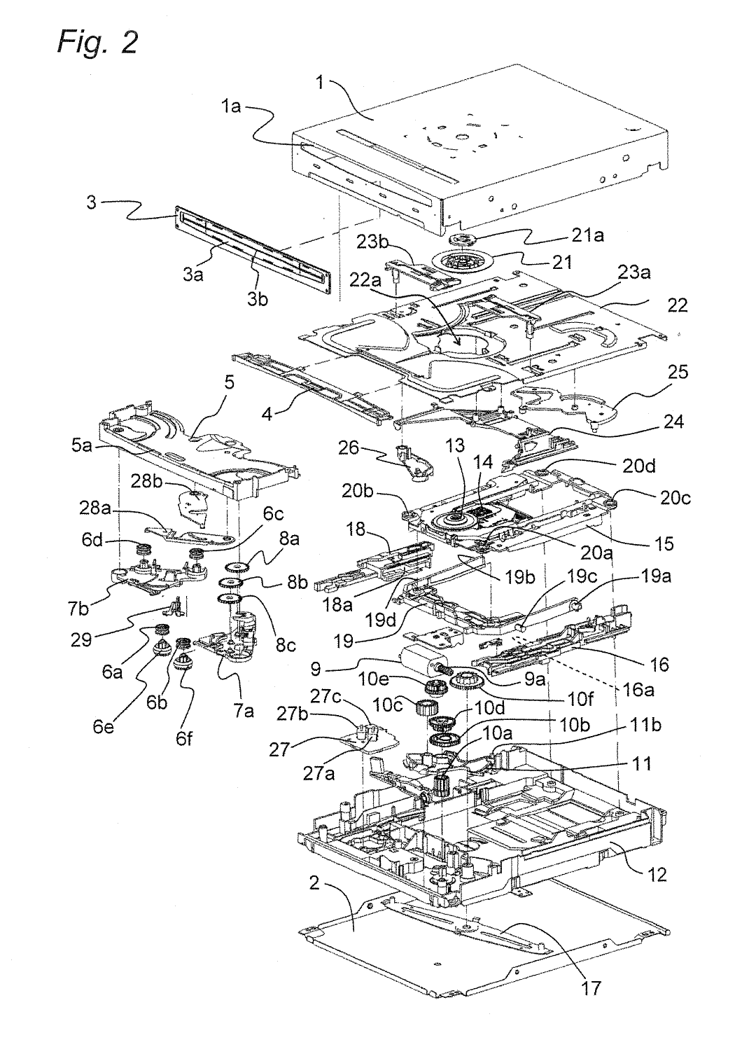

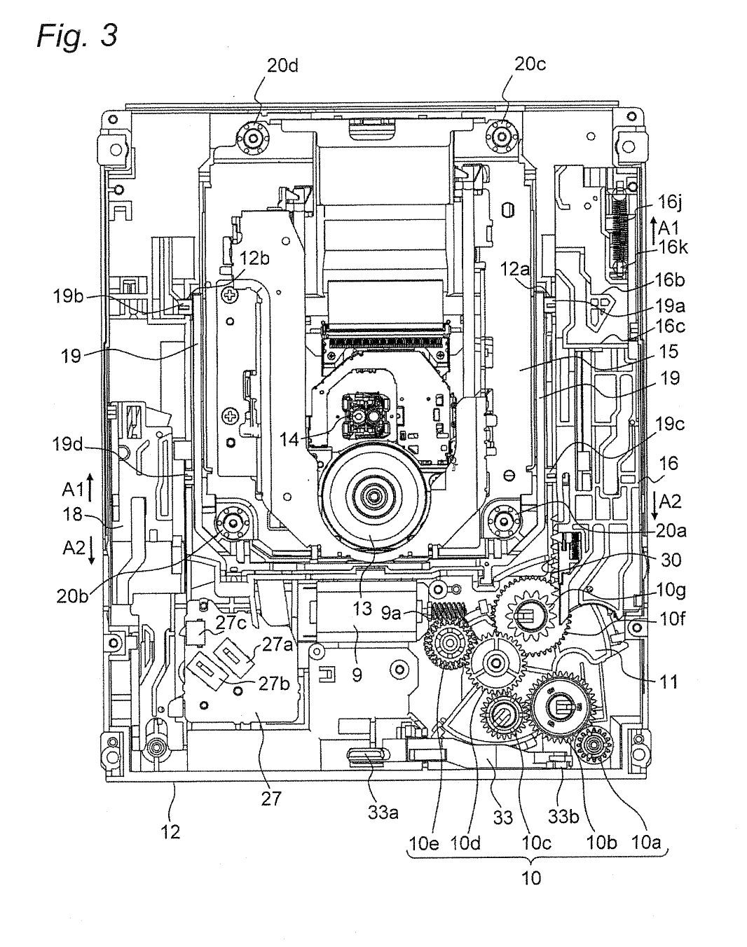

Hereinafter, a disk device according to a first embodiment of the present invention will be described. FIG. 1 is a perspective outer appearance view showing the disk device according to the first embodiment and a disk. FIG. 2 is an exploded perspective view of the disk device of FIG. 1. FIG. 3 is a top view showing attachment states of parts to be attached to a mechanical chassis provided in the disk device of FIG. 1. For convenience, the upper side of FIG. 1 indicates the upper side of the disk device, and the lower side of FIG. 1 indicates the lower side of the disk device. However, the present invention is not limited thereto. For example, the disk device may be tilted by 90°. That is, the disk device is not limited to be horizontally arranged as shown in FIG. 1 but may be arranged perpendicularly or the like.

In FIG. 1, the disk device is provided with an upper cover 1 and a lower cover 2 forming a casing 300 serving as an outer shell of the device. An opening portion 1a for disk insertion and ejection is provided in a front surface of the upper cover 1. The opening portion 1a is closed by an anti-dust cover 3. The anti-dust cover 3 is provided with an elastic sheet 3a made of felt or the like. A slit 3b through which a large-diameter disk 100 and a small-diameter disk 200 can pass is formed substantially in a center (at a position facing the opening portion 1a) of the elastic sheet. A front end of the large-diameter disk 100 or the small-diameter disk 200 is inserted into the casing 300 through the slit 3b and the opening portion 1a while elastically deforming the anti-dust cover 3, so that a disk conveyance mechanism arranged in the casing 300 and described later is driven and the large-diameter disk 100 or the small-diameter disk 200 is conveyed to a replayable position. The large-diameter disk 100 indicates for example a disk having a standard diameter of 12 cm. The small-diameter disk 200 indicates for example a disk having a standard diameter of 8 cm. Hereinafter, when matters regarding both the large-diameter disk and the small-diameter disk are described and there is no particular need for distinguishing those disks, each of those disks will be referred to as the “disk”.

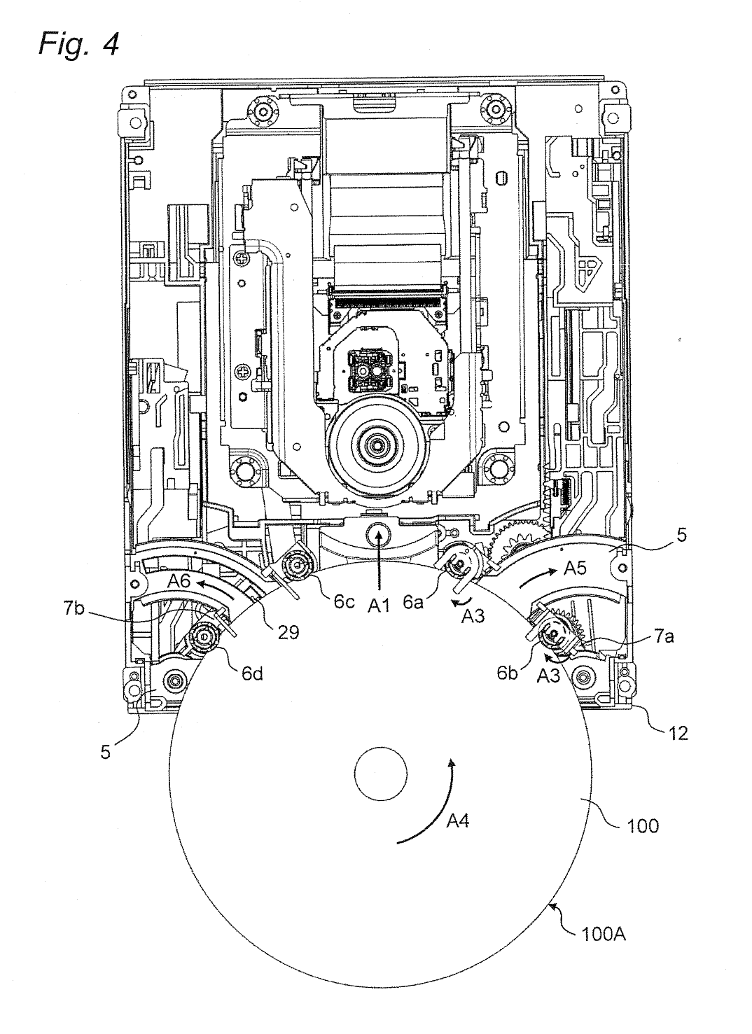

An upper guide 4 for guiding the upper side of the disk and a roller base 5 for guiding the lower side of the disk with a guide portion 5a are provided in the vicinity of the opening portion 1a inside the casing 300. The roller base 5 rotatably retains a pair of roller arms 7a, 7b functioning as a guide and a drive force transmission portion for conveying the disk into the casing 300 (refer to FIG. 4). A pair of rubber rollers 6a, 6b is rotatably provided to the roller arm 7a. A pair of rubber rollers 6c, 6d is fixed to the roller arm 7b. The rubber roller 6a is integrated with a roller gear 6e (refer to FIG. 2). The rubber roller 6b is integrated with a roller gear 6f.

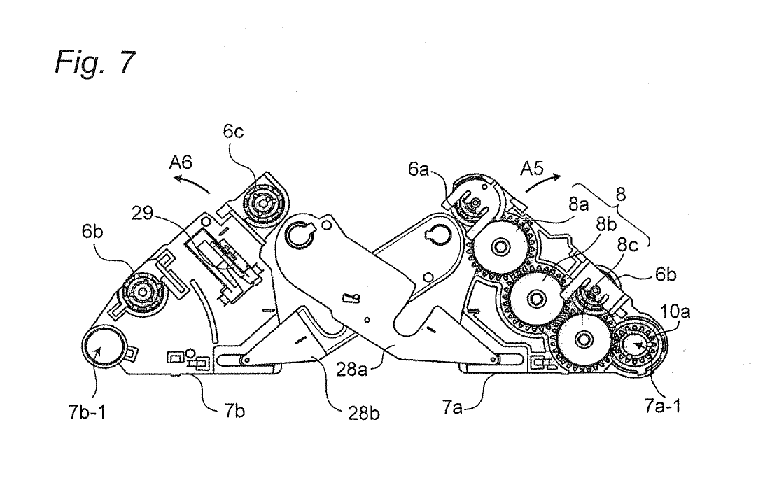

A gear row 8 formed by gears 8a to 8c is provided to the roller arm 7a (refer to FIG. 7). The gear 8c is meshed with a gear 10a in a gear row 10 formed by gears 10a to 10e shown in FIG. 3. The gear 10e is meshed with a worm gear 9a provided in a motor 9 serving as one example of a drive source. Accordingly, drive force of the motor 9 is transmitted to the gear row 8 via the worm gear 9a, the gears 10e, 10d, 10c, 10b, and 10a in the gear row 10. Since a gear 10f is meshed with a lower portion of the gear 10d, the drive force is transmitted at the same time, and a pinion 10g is coaxially integrated with this gear 10f. The pinion 10g is capable of being meshed with a rack 30 provided to a slide cam member 16 to be described later. However, in an initial state that the disk is not inserted, the pinion 10g is not meshed with the rack 30. The gear 10c is rotatably and axially supported on a clutch plate 11. The clutch plate 11 is rotatably provided with the up and down direction (also called as the thickness direction) as a rotation axis thereof. As described later, rotation of the clutch plate 11 is performed by sliding of the slide cam member 16 in an arrow A2 direction. By the rotation of the clutch plate 11, the gear 10c moves, meshing with the gear 10b is released, and the drive force is transmitted only to the gear 10f and the coaxial pinion 10g. The roller base 5, the gear row 8, the motor 9, and the gear row 10 are rotatably or slidably retained on the mechanical chassis 12 arranged in the casing 300 according to need.

As shown in FIG. 2, a turntable 13 on which the disk is mounted and a traverse base 15 having an optical pickup 14 are arranged inside the casing 300. The turntable 13 is integrated with a spindle motor (not shown) for generating rotation force to rotate the disk. The traverse base 15 is rotatable in the up and down direction and floated and supported on the mechanical chassis 12 with fixed elasticity. By rotation of the traverse base 15, the disk conveyed to the replayable position can be installed onto the turntable 13.

As shown in FIG. 3, on the right side of the mechanical chassis 12, the slide cam member 16 is provided slidably in an arrow A1 or A2 direction. On the left side of the mechanical chassis 12, a slide cam member 18 is provided slidably in the arrow A1 or A2 direction. The slide cam member 16 and the slide cam member 18 are coupled by a link arm 17 (refer to FIG. 2) which is rotatably supported on a lower part of the mechanical chassis 12, and formed to slide in the opposite directions to each other by rotation of the link arm 17. An intermediate chassis 19 for supporting the traverse base 15 is axially supported by pins 19a, 19b and thus rotatably provided in the mechanical chassis 12. Pins 19c, 19d to be engaged with raising and lowering cams 16a, 18a (refer to FIG. 2) formed to the slide cam members 16, 18 are provided to the intermediate chassis 19. The slide cam members 16, 18 slide in the opposite directions to each other, so that the pins 19c, 19d move along the raising and lowering cams 16a, 18a and thus are raised or lowered, and the intermediate chassis 19 is rotated taking the pins 19a, 19b as a rotation axis.

A front part of the traverse base 15 (on the side of the opening portion 1a) is fixed to a front part of the intermediate chassis 19 at one point on the left side and at one point on the right side via floating rubbers 20a, 20b. A rear part of the traverse base 15 is floated and supported on the mechanical chassis 12 via floating rubbers 20c, 20d. The intermediate chassis 19 is rotated taking the pins 19a, 19b as the rotation axis, so that the traverse base 15 is rotated taking the floating rubbers 20d, 20c as a rotation axis. In accordance with this rotating operation of the traverse base 15, the turntable 13 is raised or lowered.

Above the turntable 13, an upper base 22 is arranged so as to cover an upper part of the traverse base 15. An opening portion 22a is provided in the upper base 22 at a position facing the turntable 13. To the upper base 22, a pair of facing clamper lifters 23a, 23b sandwiching the opening portion 22a is provided slidably in the direction in which the clamper lifters are brought close to or away from each other. Above the turntable 13, a clamper 21 for clamping the disk onto the turntable 13 is provided.

When the pair of clamper lifters 23a, 23b is placed close to each other, the clamper 21 is supported on ends of the clamper lifters 23a, 23b. At this time, the clamper 21 is in a non-contact state with the disk mounted on the turntable 13. When the pair of clamper lifters 23a, 23b moves in the direction in which the clamper lifters are brought away from each other from this state, the clamper 21 moves close to the turntable 13 through the opening portion 22a.

A metal yoke 21a is provided in the clamper 21. A magnet provided in the turntable 13 attracts the metal yoke 21a with magnetic force in a state that the disk is mounted on the turntable 13, so that the disk is nipped between the clamper 21 and the turntable 13. Thereby, the disk is installed onto the turntable 13 and brought into a replayable clamping state. When the pair of clamper lifters 23a, 23b moves in the direction in which the clamper lifters are brought close to each other from this clamping state, the clamper 21 pressed by the pair of clamper lifters 23a, 23b due to the movement moves away from the turntable 13 against the magnetic force. Thereby, the clamping state is cancelled.

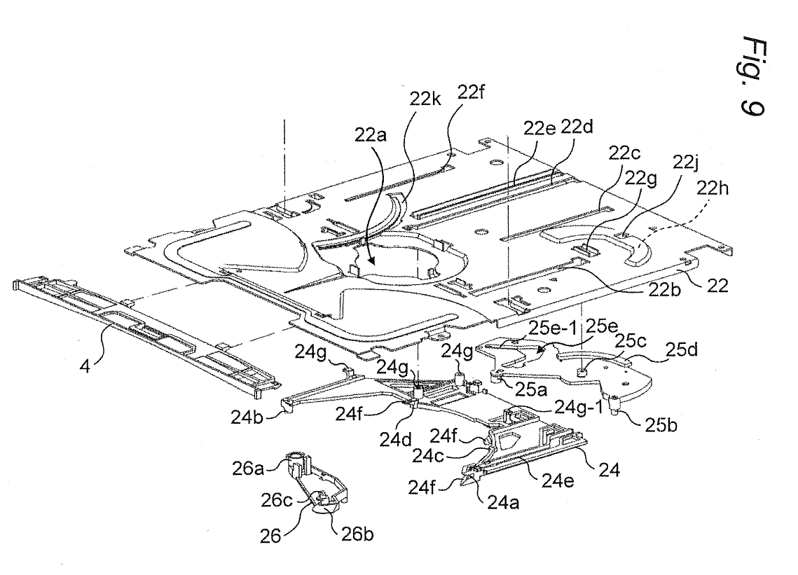

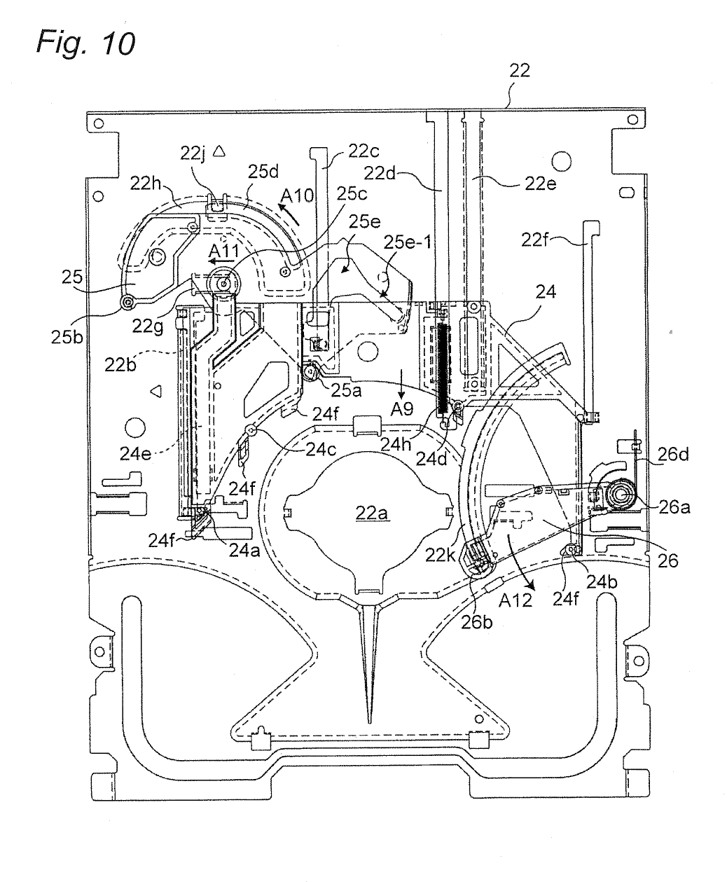

A centering member 24 for centering the disk toward the replayable position is slidably provided on a lower surface of the upper base 22. A trigger lever 25 serving as one example of a trigger member rotated by being contacted with and pressed by the disk conveyed to the replayable position is rotatably provided on the lower surface of the upper base 22 (refer to FIGS. 9 and 10). A guide lever 26 for stably retaining the disk inserted into the casing 300 between the turntable 13 and the clamper 21 is rotatably provided on the lower surface of the upper base 22. The upper base 22 is fixed to the mechanical chassis 12. The mechanical chassis 12 is nipped between the upper cover 1 and the lower cover 2 and thus fixed.

A substrate 27 onto which detection switches 27a to 27c are disposed is attached to the mechanical chassis 12 (refer to FIG. 3). The detection switch 27a detects the disk inserted through the opening portion 1a. As shown in FIG. 7, the detection switch 27a is operated by a disk detection lever 29 provided to the roller arm 7b. The detection switch 27b detects that loading is finished at the time of the ejection of the disk. The detection switch 27b is operated by a lower surface of the roller arm 7b rotating at the time of inserting and ejecting the disk. The detection switch 27c detects that the disk is conveyed to the replayable position and installment thereof is completed. The detection switch 27c is operated by the slide cam member 18. The substrate 27 is provided at a position facing the roller arm 7b attached to the roller base 5.

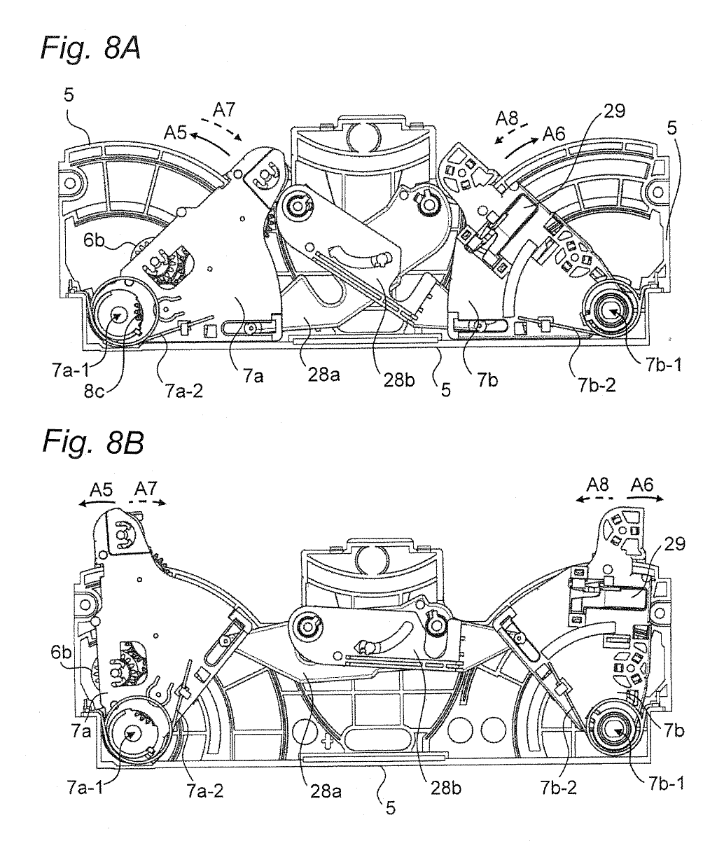

As shown in FIGS. 7, 8A, and 8B, link arms 28a, 28b are rotatably provided to the roller base 5. The link arms 28a, 28b are engaged with the roller arms 7a, 7b so as to rotate the roller arms 7a, 7b in synchronization with each other. The roller arm 7a is provided rotatably in an arrow A5 direction and an arrow A7 direction about a rotation shaft 7a-1. This roller arm 7a is biased in the A7 direction by a twist coil spring 7a-2. The roller arm 7b is provided rotatably in an arrow A6 direction and an arrow A8 direction about a rotation shaft 7b-1. This roller arm 7b is biased in the arrow A8 direction by a twist coil spring 7b-2.

It is noted that in the first embodiment, the disk conveyance mechanism for conveying the disk to the replayable position is formed by the gear row 10, the gear row 8, the rubber rollers 6a to 6d, the roller gears 6e, 6f, the roller arms 7a, 7b, and the link arms 28a, 28b. In the first embodiment, a disk installment mechanism for installing the disk conveyed to the replayable position onto the turntable 13 so as to bring the disk into the replayable clamping state is formed by the gears 10d to 10f, the pinion 10g, the slide cam member 16, the link arm 17, the slide cam member 18, the intermediate chassis 19, the traverse base 15, the floating rubbers 20a to 20d, the clamper 21, the upper base 22, and the clamper lifters 23a, 23b. In the first embodiment of the present invention, a transmission route switching mechanism for switching a transmission route of the drive force so that the drive force generated by the drive source is transmitted only to one of the disk conveyance mechanism and the disk installment mechanism is formed by the clutch plate 11, the slide cam member 16 for driving this clutch plate, and the trigger lever 25. The motor 9 serving as the drive source and the worm gear 9a serve as common constituent parts relating to drive of the mechanisms, and there are some parts such as the gear row 10 part of which is used for the drive of a plurality of mechanisms. It is noted that the disk conveyance mechanism, the disk installment mechanism, and the transmission route switching mechanism of the present invention are not limited to the above described configurations, needless to say.

Next, with reference to FIG. 3, the configuration of the disk device will be described further in detail. FIG. 3 is the top view showing a state that parts excluding those parts relating to the upper cover 1, the lower cover 2, the roller base 5 and parts relating to the upper base 22 are attached to the mechanical chassis 12 in the entire configuration shown in FIG. 2.

As shown in FIG. 3, the turntable 13 and the optical pickup 14 are arranged on the traverse base 15 substantial in a center of the disk device. The intermediate chassis 19 in a substantially U shape is arranged so as to surround the front part and both side parts of the traverse base 15. The slide cam member 16 is arranged on the right side of the intermediate chassis 19. The slide cam member 18 is arranged on the left side of the intermediate chassis 19. The slide cam member 16 and the slide cam member 18 are arranged slidably in the front and rear direction (the arrow A1 and A2 directions) which is the same as the disk conveying direction. In the initial state that the disk is not conveyed, the slide cam member 16 is biased in the arrow A1 direction by a spring 16j extended between the mechanical chassis 12 and the slide cam member 16. The slide cam member 18 connected to the slide cam member 16 via the link arm 17 is biased in the arrow A2 direction. The pins 19c, 19d provided at both ends of the front part of the intermediate chassis 19 are slidably engaged with the raising and lowering cams 16a, 18a formed to the slide cam members 16, 18 (refer to FIG. 2). The pins 19a, 19b provided at both ends of a rear part of the intermediate chassis 19 are rotatably retained on bearing portions 12a, 12b formed to the mechanical chassis 12. With this configuration, the slide cam members 16, 18 slide in the opposite directions to each other, so that the intermediate chassis 19 is rotated taking the pins 19a, 19b as the rotation axis and the front part of the intermediate chassis 19 is raised or lowered.

Sliding of the slide cam members 16, 18 in the opposite directions to each other is performed by transmitting the drive force of the motor 9 to the pinion 10g via the worm gear 9a, and the gears 10e, 10d, 10f in a state that the rack 30 of the slide cam member 16 and the pinion 10g are meshed with each other. The trigger lever 25 is rotated by being pressed by the disk conveyed to the replayable position on the turntable 13, and the slide cam member 16 is pressed by the trigger lever 25 and thus slightly slides in the arrow A2 direction, so that the pinion 10g is meshed with the rack 30.

That is, when the disk is conveyed to the replayable position with the drive of the motor 9, by an action of the trigger lever 25 and transmission switching of the drive force of the motor 9, the slide cam members 16, 18 slide in the opposite directions to each other. Thereby, the intermediate chassis 19 and the traverse base 15 are raised, and the disk is installed onto the turntable 13 and thus brought into the replayable clamping state.

Next described with reference to FIGS. 4 to 8B is a conveyance operation of the large-diameter disk 100 for conveying the large-diameter disk 100 inserted into the casing 300 to the replayable position. FIGS. 4 to 6 are top views showing conveying states of the large-diameter disk. FIG. 7 is a top view showing an attachment state of the pair of roller arms 7a, 7b and the pair of link arms 28a, 28b. FIGS. 8A and 8B are bottom views showing a state that the pair of roller arms 7a, 7b is rotated in the direction in which the roller arms are brought close to or away from each other.

FIG. 4 shows a state immediately after the large-diameter disk 100 is inserted into the casing 300. At this time, the large-diameter disk 100 is contacted with the pair of rubber rollers 6a, 6b on the right side and the pair of rubber rollers 6c, 6d on the left side. At this time, the disk detection lever 29 provided to the roller arm 7b is rotated by being pressed by the large-diameter disk 100, so that the detection switch 27a is operated so as to detect that the large-diameter disk 100 is inserted through the opening portion 1a. When the detection switch 27a is operated, the motor 9 starts driving. The drive force of the motor 9 is transmitted to the rubber rollers 6a, 6b via the gear row 10 and the gear row 8. Thereby, the rubber rollers 6a, 6b are rotated in an arrow A3 direction, and by rotation drive force and friction force of the rubber roller 6b and friction force of the non-rotated rubber roller 6d facing the rubber roller 6b while sandwiching the large-diameter disk 100, the large-diameter disk 100 is rotated in an arrow A4 direction taking the rubber roller 6d (in more detail, an contact point with the large-diameter disk 100) as a rotation axis. By this rotation in the arrow A4 direction, the large-diameter disk 100 is conveyed in the arrow A1 direction.

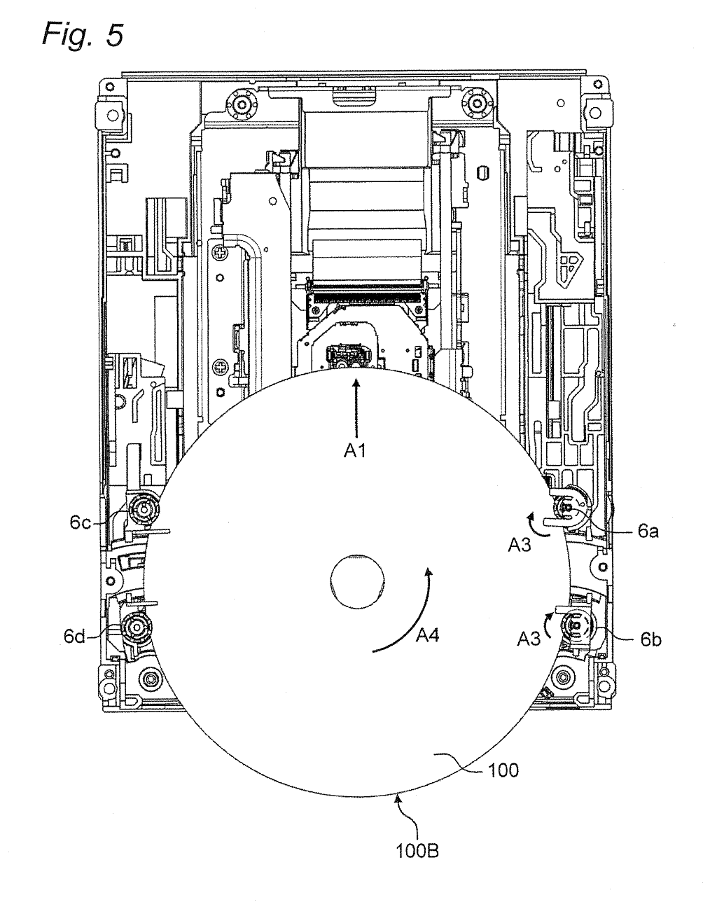

When the large-diameter disk 100 is conveyed in the arrow A1 direction from the state shown in FIG. 4, the large-diameter disk 100 extends a gap between the rubber roller 6b and the rubber roller 6d. Thereby, against bias force of the twist coil springs 7a-2, 7b-2 described with reference to FIG. 2, the roller arm 7a is rotated in the arrow A5 direction, and the roller arm 7b is rotated in the arrow A6 direction. That is, the pair of roller arms 7a, 7b is rotated in the directions in which the roller arms are brought away from each other (opening directions). By the rotation of the roller arms 7a, 7b, the rubber rollers 6a, 6c are once brought away from a peripheral part of the disk 100. After that, when the large-diameter disk 100 is further conveyed in the arrow A1 direction and a center part of the disk 100 having the maximum diameter in the left and right direction of the disk 100 passes through the gap between the rubber rollers 6b, 6d, the roller arm 7a is rotated in the arrow A7 direction, and the roller arm 7b is rotated in the arrow A8 direction by the bias force of the twist coil springs 7a-2, 7b-2 described with reference to FIG. 8. That is, the pair of roller arms 7a, 7b is rotated in the directions in which the roller arms are brought close to each other (closing directions). Thereby, the rubber rollers 6a, 6c are contacted with the peripheral part of the disk 100 again and brought into the state shown in FIG. 5.

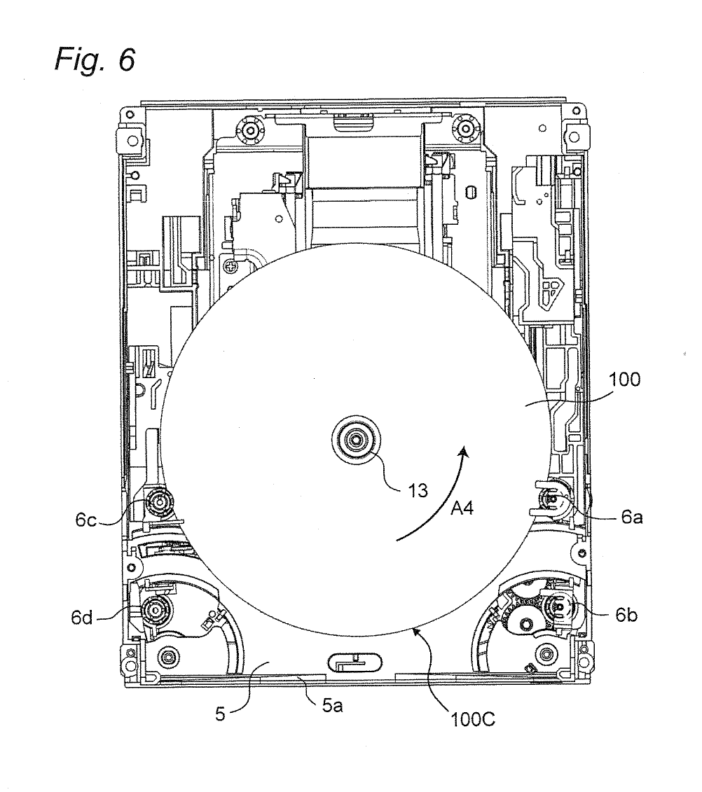

FIG. 5 shows a state that all the rubber rollers 6a to 6d are contacted with the large-diameter disk 100. FIG. 6 shows a state that the large-diameter disk 100 is conveyed to the replayable position. The large-diameter disk 100 passes through a disk position 100B shown in FIG. 5 in a process of conveyance from a disk position 100A immediately after insertion into the casing 300 (refer to FIG. 4) to a disk position 1000 serving as the replayable position (refer to FIG. 6). At this disk position 100B, rotation force for the large-diameter disk 100 is switched to be transmitted from the rubber rollers 6a, 6c instead of the rubber rollers 6b, 6d. That is, from this disk position 100B to the disk position 100C, the large-diameter disk 100 is rotated in the arrow A4 direction taking the rubber roller 6c as a rotation center by rotation drive force of the rubber roller 6a. By this rotation in the arrow A4 direction taking the rubber roller 6c as the rotation center, the large-diameter disk 100 is further conveyed in the arrow A1 direction. The large-diameter disk 100 is conveyed to the disk position 100C shown in FIG. 6. At this position, the conveyance operation of the disk 100 is finished. This conveyance is detected, so that an installment operation for clamping the disk 100 onto the turntable 13 to be described later is performed. When the detection switch 27c detects that the installment operation is completed, the motor 9 stops driving. Thereby, the conveyance operation and the installment operation of the large-diameter disk 100 are completed.

Next, an ejection operation of the large-diameter disk 100 will be described. It is noted that the large-diameter disk 100 is placed at the disk position 100C shown in FIG. 6, the clamping state is cancelled, and the large-diameter disk is nipped by the rubber rollers 6a, 6c.

Firstly, the motor 9 is already reversely driven for canceling the clamping state, and the rubber rollers 6a, 6b are rotated in the opposite direction to that of the conveyance operation of the large-diameter disk 100. Thereby, the large-diameter disk 100 is rotated in the opposite direction to the arrow A4 direction taking the rubber roller 6c as the rotation center. By this rotation in the opposite direction to the arrow A4 direction, the large-diameter disk 100 is conveyed in the opposite direction to the arrow A1 direction (that is, the arrow A2 direction).

When the large-diameter disk 100 reaches the disk position 100B shown in FIG. 5 by the conveyance in the opposite direction to the arrow A1 direction, the rotation force of the large-diameter disk 100 is switched to be transmitted from the rubber rollers 6b, 6d instead of the rubber rollers 6a, 6c. Thereby, the large-diameter disk 100 is rotated in the opposite direction to the arrow A4 direction taking the rubber roller 6d as the rotation center. By this rotation in the opposite direction to the arrow A4 direction, the large-diameter disk 100 is further conveyed in the opposite direction to the arrow A1 direction. When the detection switch 27b detects that the large-diameter disk 100 is conveyed to the disk position 100A shown in FIG. 4 by this conveyance in the opposite direction to the arrow A1 direction, the motor 9 stops driving. Thereby, the ejection operation of the large-diameter disk 100 is completed.

It is noted that the large-diameter disk 100 ejected to the disk position 100A shown in FIG. 4 can be taken out by fingers of a user. At this time, with nipping force and friction force of the rubber rollers 6a to 6d as well as elastic force and friction force of the anti-dust cover 3, the large-diameter disk 100 is retained without popping out from the opening portion 1a to the exterior of the casing 300.

Next, with reference to FIGS. 9 and 10, configurations of the centering member 24, the trigger lever 25, and the guide lever 26 slidably or rotatably attached on the lower surface of the upper base 22 will be described further in detail. FIG. 9 is an exploded perspective view showing configurations of parts relating to the upper base 22. FIG. 10 is a bottom view showing a state that the parts shown in FIG. 9 are attached to the upper base 22.

The centering member 24 is provided with positioning contact portions 24a, 24b to be contacted with the large-diameter disk 100 so as to center the large-diameter disk, and positioning contact portions 24c, 24d to be contacted with the small-diameter disk 200 so as to center the small-diameter disk. The centering member 24 is also provided with a guide cam 24e serving as one example of a guide portion to be engaged with the trigger lever 25 so as to rotate the trigger lever 25, and a plurality of position regulating guides 24f for regulating a position of the disk in the thickness direction. The guide cam 24e has a first straight cam portion 24e-1 and a second straight cam portion 24e-3 provided in parallel to the disk conveying direction, and a tilt cam portion 24e-2 provided in a crossing direction to the disk conveying direction to couple the first straight cam portion 24e-1 and the second straight cam portion 24e-3.

The centering member 24 is provided with a plurality of sliding guides 24g such as pins and claw pieces. The sliding guides 24g are engaged with guide holes 22b to 22f formed in the upper base 22, so that the centering member 24 is slidable in the disk conveying direction along the lower surface of the upper base 22. As shown in FIG. 10, the centering member 24 is biased in an arrow A9 direction (disk ejecting direction) by a spring 24h extended between the centering member and the upper base 22. Thereby, the centering member 24 imparts bias force in the arrow A9 direction to the disk inserted into the casing 300, so as to center the disk.

The trigger lever 25 is rotated by being contacted with the disk conveyed to the replayable position, so as to impart initial sliding to the slide cam member 16. The slide cam member 16 drives the disk installment mechanism by this initial sliding. The trigger lever 25 is provided with a disk contact portion (also called as the detection portion) 25a to be contacted with the disk, a slide cam pressing portion 25b to be engaged with the slide cam member 16 so as to press the slide cam member 16 in the arrow A2 direction (refer to FIG. 3), and a rotation shaft portion 25c serving as a rotation center of the trigger lever 25.

The rotation shaft portion 25c of the trigger lever 25 is engaged with an elongated circular axial hole 22g formed in the upper base 22, and also engaged with the guide cam 24e of the centering member 24. Thereby, the trigger lever 25 is rotated in an arrow A10 direction or the opposite direction thereof about a crossing part of the axial hole 22g and the guide cam 24e.

The trigger lever 25 is provided with an arc shape convex portion 25d so that the trigger lever can be rotated while being retained by the upper base 22. The upper base 22 is provided with a concave portion 22h in which the arc shape convex portion 25d is arranged, and an engagement claw portion 22j to be engaged with the arc shape convex portion 25d so that the arc shape convex portion 25d is not disengaged with the concave portion 22h. The concave portion 22h is formed so as to be larger than the arc shape convex portion 25d so that the trigger lever 25 can be rotated even when the rotation shaft portion 25c moves in an arrow A11 direction or the opposite direction thereof in the axial hole 22g.

There is formed in the trigger lever 25 a hole 25e through which a sliding guide 24g-1 serving as one of the plurality of sliding guides 24g of the centering member 24 passes. A link groove 25e-1 is formed in this hole 25e.

The guide lever 26 is provided to retain the disk inserted into the casing 300 at a height between the turntable 13 and the clamper 21. The guide lever 26 is provided with a rotation shaft 26a rotatably and axially supported on the upper base 22, and a positioning guide 26b for retaining the height of the disk.

In order to stabilize a position in the height direction of the guide lever 26 itself, the guide lever 26 is provided with an engagement claw piece 26c to be engaged with an arc shape hole 22k formed in the upper base 22. The guide lever 26 is biased in an arrow A12 direction by a twist coil spring 26d, and normally retained in the state shown in FIG. 10. The disk inserted into the casing 300 is contacted with the positioning guide 26b and conveyed to the replayable position while rotating the guide lever 26 in the opposite direction to the arrow A12 against bias force of the spring 26d.

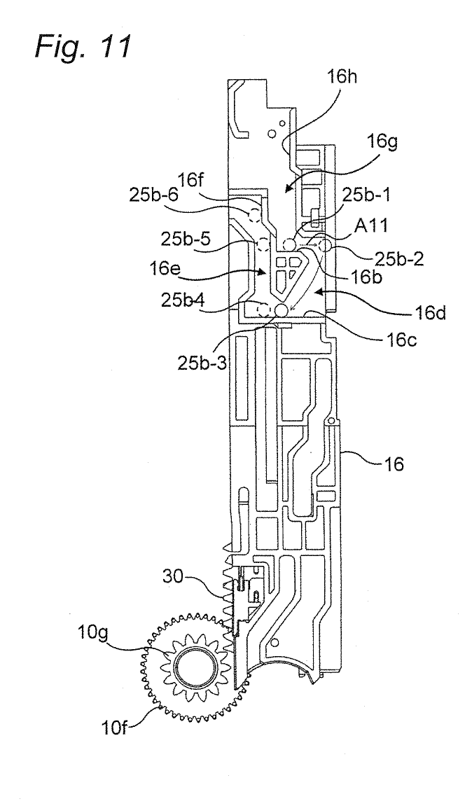

Next, with reference to FIGS. 11 to 22, the disk conveyance operation and the disk installment operation will be described.

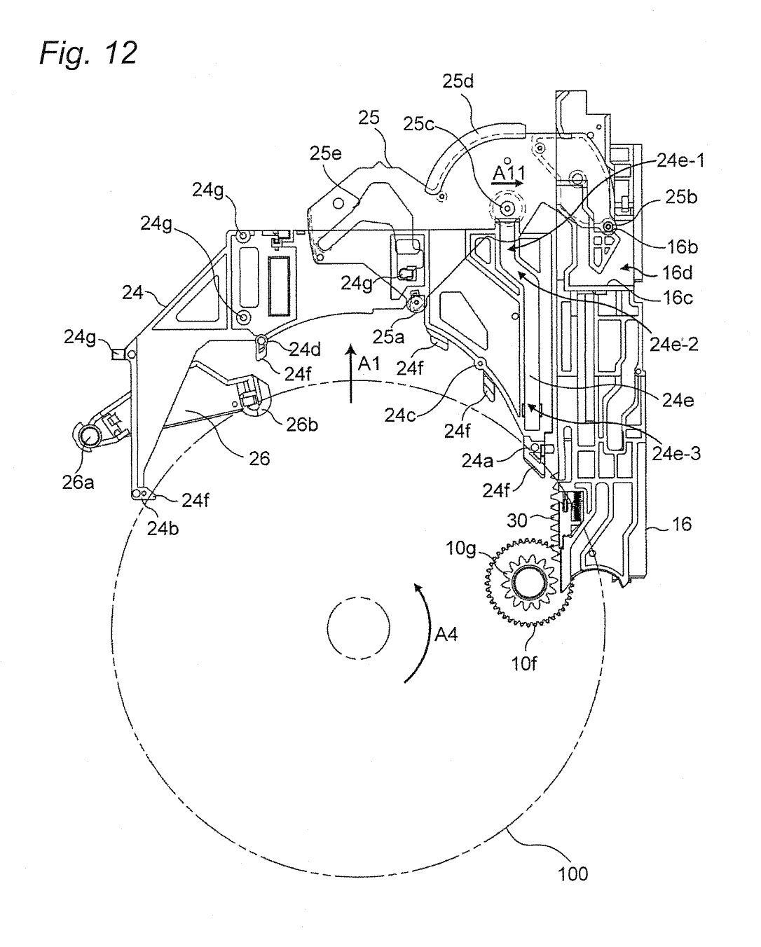

Firstly, with reference to FIGS. 11 to 16, operations of the parts in the case where the large-diameter disk 100 is inserted into the casing 300 will be described. FIG. 11 is a top view showing a relative movement trajectory of the slide cam pressing portion 25b of the trigger lever 25 relative to engagement portions formed to the slide cam member 16 at the time of inserting the large-diameter disk. FIGS. 12 to 16 are top views showing positional relationships among the slide cam member 16, the centering member 24, the trigger lever 25, and the guide lever 26 when the large-diameter disk 100 inserted into the casing 300 is conveyed to the replayable position. It is noted that in these figures, part of the parts is transparently shown for convenience.

As shown in FIG. 11, the slide cam member 16 is provided with a first engagement portion 16b and a second engagement portion 16c as the engagement portions to which the slide cam pressing portion 25b of the trigger lever 25 is engaged. The first engagement portion 16b is a part to be pressed by the slide cam pressing portion 25b when the trigger lever 25 is rotated by being pressed by the small-diameter disk 200. The second engagement portion 16c is a part to be pressed by the slide cam pressing portion 25b when the trigger lever 25 is rotated by being pressed by the large-diameter disk 100. The slide cam member 16 is provided with cam portions 16d to 16f. The cam portion 16d is formed so as to connect the first engagement portion 16b and the second engagement portion 16c. The cam portion 16d is a part for guiding movement of the slide cam pressing portion 25b from the first engagement portion 16b to the second engagement portion 16c when the large-diameter disk 100 is inserted into the casing 300 and the rotation shaft portion 25c of the trigger lever 25 moves. The cam portion 16e is a part for moving the slide cam pressing portion 25b so as to bring the slide cam pressing portion away from the second engagement portion 16c when the large-diameter disk 100 is installed onto the turntable 13 after being conveyed to the replayable position. The cam portion 16f is a part for bringing the positioning contacted portions 24a, 24b and the like of the centering member 24 away from the large-diameter disk 100. The positional relationships between the parts are changed as shown in FIGS. 12 to 16, so that the slide cam pressing portion 25b of the trigger lever 25 follows the trajectory of positions 25b-1 to 25b-6.

When the large-diameter disk 100 is inserted into the casing 300, firstly, the vicinity of the front end of the large-diameter disk 100 is contacted with the positioning guide 26b of the guide lever 26, so that the height in the thickness direction of the large-diameter disk 100 is determined.

Next, as described with reference to FIG. 4, the large-diameter disk 100 is conveyed in the arrow A1 direction while being rotated in the arrow A4 direction. Thereby, the guide lever 26 is pressed by the large-diameter disk 100 and rotated about the rotation shaft 26a against the bias force of the twist coil spring 24h, and as shown in FIG. 12, the large-diameter disk 100 is contacted with the positioning contact portions 24a, 24b of the centering member 24. The peripheral part of the large-diameter disk 100 is contacted with both the positioning contact portions 24a, 24b, so that the large-diameter disk 100 is centered. That is, the center of the large-diameter disk 100 is positioned so as to be placed on a straight line parallel to the disk conveying direction in plan view, the straight line running through the center of the turntable 13.

It is noted that in the state shown in FIG. 12, the disk contact portion 25a of the trigger lever 25 is in an initial state in which the disk contact portion is not contacted with the large-diameter disk 100, and the slide cam pressing portion 25b is placed at the position 25b-1 at which the slide cam pressing portion is contacted with the first engagement portion 16b of the slide cam member 16 as shown in FIG. 11. In the state shown in FIG. 12, the rotation shaft portion 25c of the trigger lever 25 is not guided by the guide cam 24e of the centering member 24.

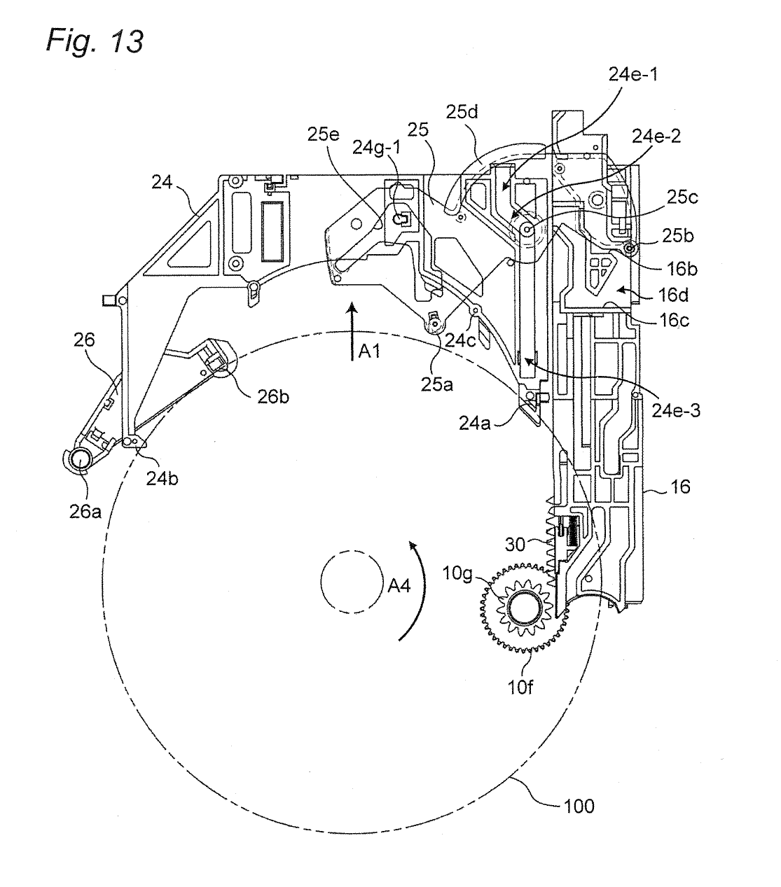

When the large-diameter disk 100 is further conveyed in the arrow A1 direction from the state shown in FIG. 12, the large-diameter disk 100 moves the centering member 24 in the arrow A1 direction against the bias force of the spring 24h, and also rotates the guide lever 26 against the bias force in the arrow A12 direction. Thereby, the rotation shaft portion 25c of the trigger lever 25 is guided by the tilt cam portion 24e-2 after passing through the first straight cam portion 24e-1 of the guide cam 24e. At this time, since movement in the disk conveying direction is regulated by the axial hole 22g (refer to FIGS. 9 and 10), the rotation shaft portion 25c moves in the arrow A11 direction. That is, the entire trigger lever 25 moves in the arrow A11 direction (from a first position to a second position). By this movement in the arrow A11 direction, the rotation shaft portion 25c moves from the tilt cam portion 24e-2 to the second straight cam portion 24e-3 as shown in FIG. 13. At this time, the arc shape convex portion 25d of the trigger lever 25 is guided and moved by the concave portion 22h of the upper base 22 described above with reference to FIGS. 9 and 10.

It is noted that in the state shown in FIG. 13, the disk contact portion 25a of the trigger lever 25 is not yet contacted with the large-diameter disk 100. The slide cam pressing portion 25b is placed at the position 25b-2 away from the position 25b-1 at which the slide cam pressing portion is contacted with the first engagement portion 16b of the slide cam member 16 as shown in FIG. 11. The slide cam member 16 is not yet moved.

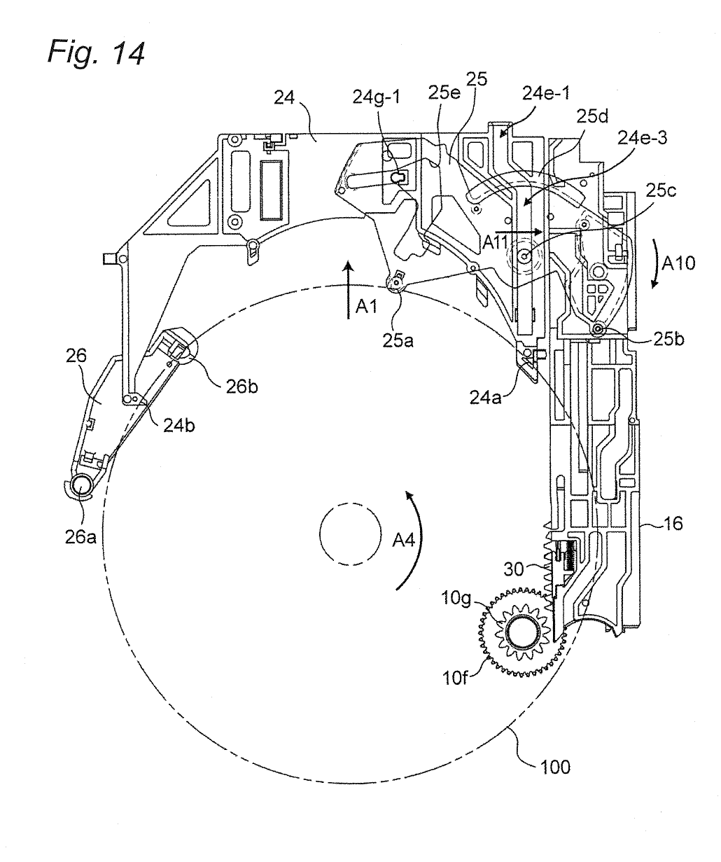

When the large-diameter disk 100 is further conveyed in the arrow A1 direction from the state shown in FIG. 13, the large-diameter disk 100 is contacted with the disk contact portion 25a of the trigger lever 25 so as to press the trigger lever 25. At this time, since the rotation shaft portion 25c of the trigger lever 25 is engaged with the axial hole 22g (refer to FIGS. 9 and 10), the movement of the trigger lever 25 in the disk conveying direction is regulated. Meanwhile, the centering member 24 is pressed by the large-diameter disk 100 and moved in the arrow A1 direction. Thereby, the tilt cam portion 24e-2 moves so as to be brought away from the rotation shaft portion 25c of the trigger lever 25, and as shown in FIG. 14, the trigger lever 25 is rotated in the arrow A10 direction about the rotation shaft portion 25c. At this time, the rotation shaft portion 25c is placed in the second straight cam portion 24e-3 (second position), the movement in the arrow A11 direction and the opposite direction thereof is regulated, and the slide cam pressing portion 25b is rotated without being disturbed by the cam portion 16d of the slide cam member 16. Thereby, the slide cam pressing portion 25b moves to the position 25b-3 at which the slide cam pressing portion is contacted with the second engagement portion 16c of the slide cam member 16 as shown in FIG. 11.

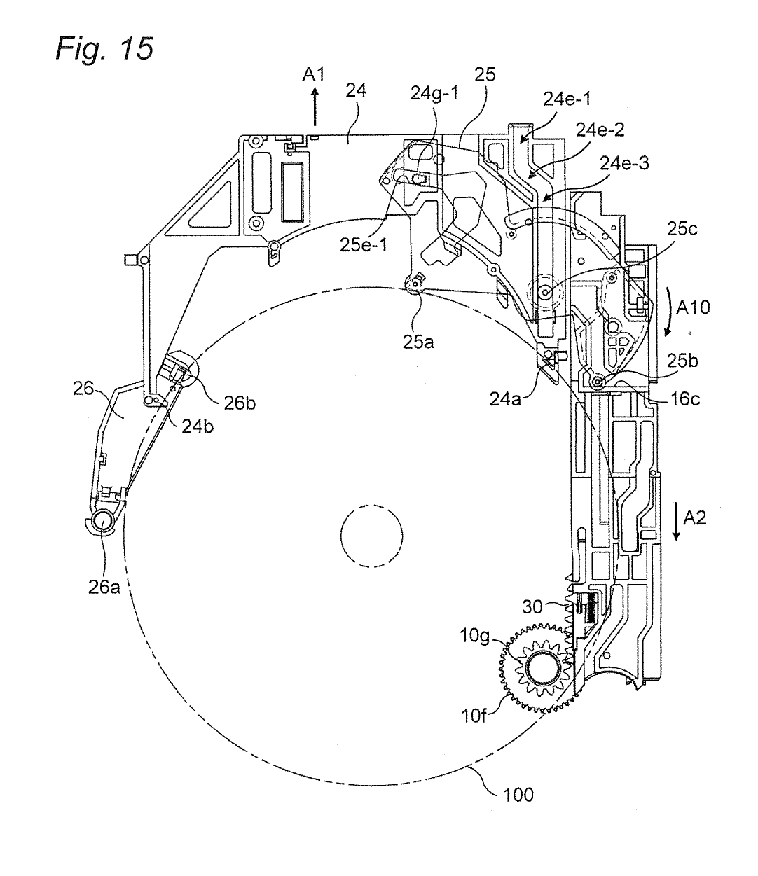

When the large-diameter disk 100 is further conveyed in the arrow A1 direction from the state shown in FIG. 14, the trigger lever 25 pressed by the large-diameter disk 100 is further rotated in the arrow A10 direction, and the slide cam pressing portion 25b presses the second engagement portion 16c of the slide cam member 16 in the arrow A2 direction. Thereby, the entire slide cam member 16 slides in the arrow A2 direction, and as shown in FIG. 15, the rack 30 of the slide cam member 16 and the pinion 10g are meshed with each other. Thereby, the conveyance operation of the large-diameter disk 100 is completed, and the installment operation thereof is started.

It is noted that in the state shown in FIG. 15, the slide cam pressing portion 25b is placed at the position 25b-4 at which the slide cam pressing portion is contacted with the second engagement portion 16c of the slide cam member 16 as shown in FIG. 11. In the state shown in FIG. 15, the large-diameter disk 100 is already conveyed to the replayable position.

Since the drive force of the motor 9 is transmitted via the gear row 10 and thus the pinion 10g is rotated in the state shown in FIG. 15, the meshed rack 30 is driven, and the slide cam member 16 further slides in the arrow A2 direction. In accordance with this sliding, the slide cam member 18 connected to the slide cam member 16 via the link arm 17 slides in the arrow A1 direction. By this sliding of the slide cam members 16, 18 in the opposite directions to each other, as described above, the installment operation of the large-diameter disk 100 onto the turntable 13 is performed. By the sliding of the slide cam member 16 in the arrow A2 direction, the second engagement portion 16c is brought away from the slide cam pressing portion 25b, and the slide cam pressing portion 25b is guided by the cam portion 16e and moved to the position 25b-5 shown in FIG. 11.

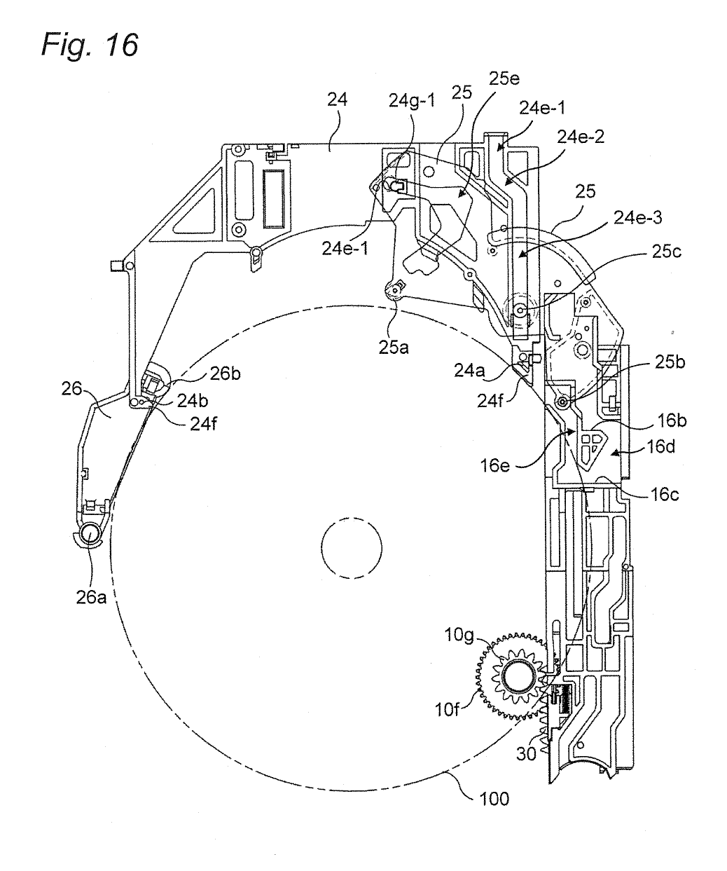

When the slide cam member 16 further slides in the arrow A2 direction from the state that the slide cam pressing portion 25b is placed at the position 25b-5, the slide cam pressing portion 25b moves from the cam portion 16e to the position 25b-6 shown in FIG. 11 above the cam portion 16f via an tilt part. At this time, the trigger lever 25 is slightly rotated in the arrow A10 direction about the rotation shaft portion 25c. By this rotation, the guide 24g-1 of the centering member 24 engaged with the link groove 25e-1 of the trigger lever 25 is pressed, and the centering member 24 slides in the arrow A1 direction. Thereby, as shown in FIG. 16, the positioning contact portions 24a, 24b and the positioning guides 24f of the centering member 24, the disk contact portion 25a of the trigger lever 25, and the positioning guide 26b of the guide lever 26 are brought away from the large-diameter disk 100, and hence rotation of the large-diameter disk 100 is not disturbed.

As described above, the installment operation of the large-diameter disk 100 is completed.

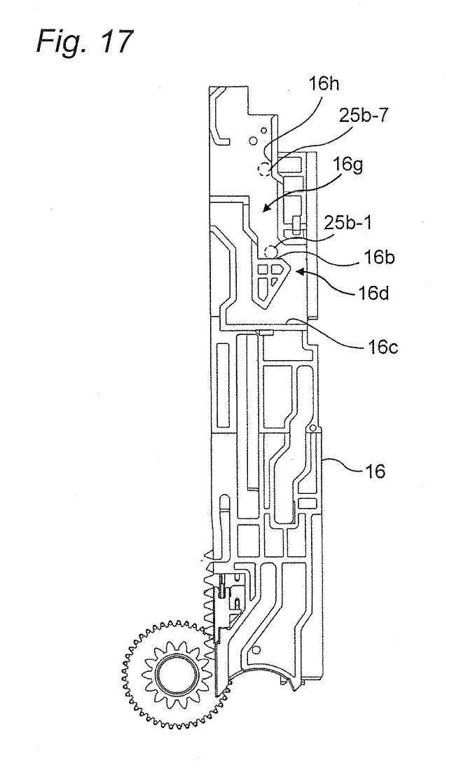

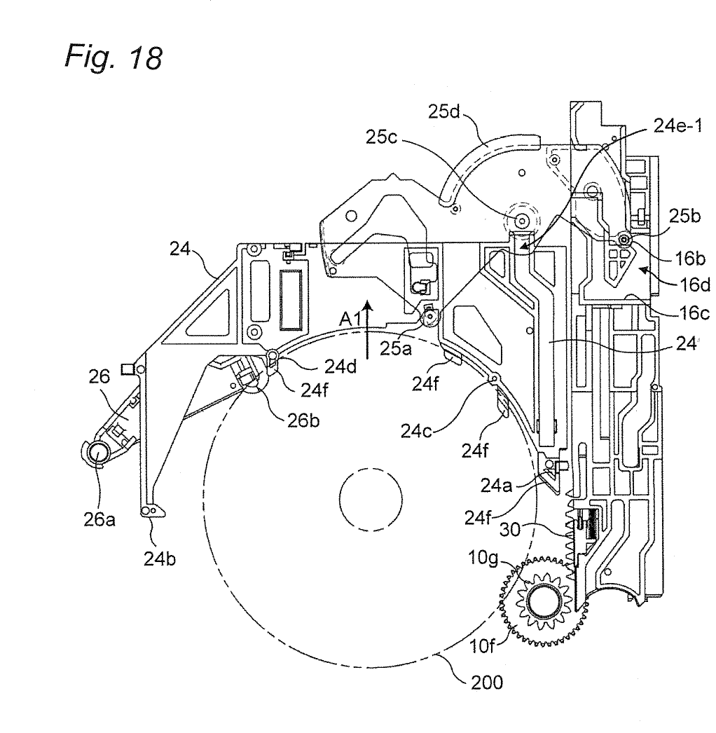

Next, with reference to FIGS. 17 to 21, operations of the parts in the case where the small-diameter disk 200 is inserted into the casing 300 will be described. FIG. 17 is a top view showing a relative movement trajectory of the slide cam pressing portion 25b of the trigger lever 25 relative to the engagement portions formed in the slide cam member 16 at the time of inserting the small-diameter disk. FIGS. 18 to 21 are top views showing positional relationships among the slide cam member 16, the centering member 24, the trigger lever 25, and the guide lever 26 when the small-diameter disk 200 inserted into the casing 300 is conveyed to the replayable position. It is noted that also in these figures, part of the parts is transparently shown for convenience.

The slide cam member 16 is provided with cam portions 16g, 16h other than the first engagement portion 16b, the second engagement portion 16c, and the cam portions 16d to 16f described with reference to FIG. 11. The cam portion 16g is a part for moving the slide cam pressing portion 25b so as to bring the slide cam pressing portion away from the first engagement portion 16b when the small-diameter disk 200 is installed onto the turntable 13 after being conveyed to the replayable position. The cam portion 16h is a part for bringing the positioning contact portions 24a, 24b and the like of the centering member 24 away from the small-diameter disk 200. The positional relationships between the parts are changed as shown in FIGS. 18 to 21, so that the slide cam pressing portion 25b of the trigger lever 25 follows the trajectory of the positions 25b-1 to 25b-7.

When the small-diameter disk 200 is inserted into the casing 300, firstly, the vicinity of the front end of the small-diameter disk 200 is contacted with the positioning guide 26b of the guide lever 26, so that the height in the thickness direction of the small-diameter disk 200 is determined. In this state, when the small-diameter disk 200 is further conveyed to the replayable position, the guide lever 26 is pressed by the small-diameter disk 200 and rotated about the rotation shaft 26a against the bias force of the twist coil spring 24h, and as shown in FIG. 18, the small-diameter disk 200 is contacted with the positioning contact portions 24c, 24d of the centering member 24. The peripheral part of the small-diameter disk 200 is contacted with the positioning contact portions 24c, 24d, so that the small-diameter disk 200 is centered. That is, the center of the small-diameter disk 200 is positioned so as to be placed on the straight line parallel to the disk conveying direction in plan view, the straight line running through the center of the turntable.

It is noted that in the state shown in FIG. 18, the disk contact portion 25a of the trigger lever 25 is in an initial state in which the disk contact portion is not contacted with the small-diameter disk 200, and the slide cam pressing portion 25b of the trigger lever 25 is placed at the position 25b-1 at which the slide cam pressing portion is contacted with the first engagement portion 16b of the slide cam member 16 as shown in FIG. 17. In a state shown in FIG. 18, the rotation shaft portion 25c of the trigger lever 25 is not guided by the guide cam 24e of the centering member 24.

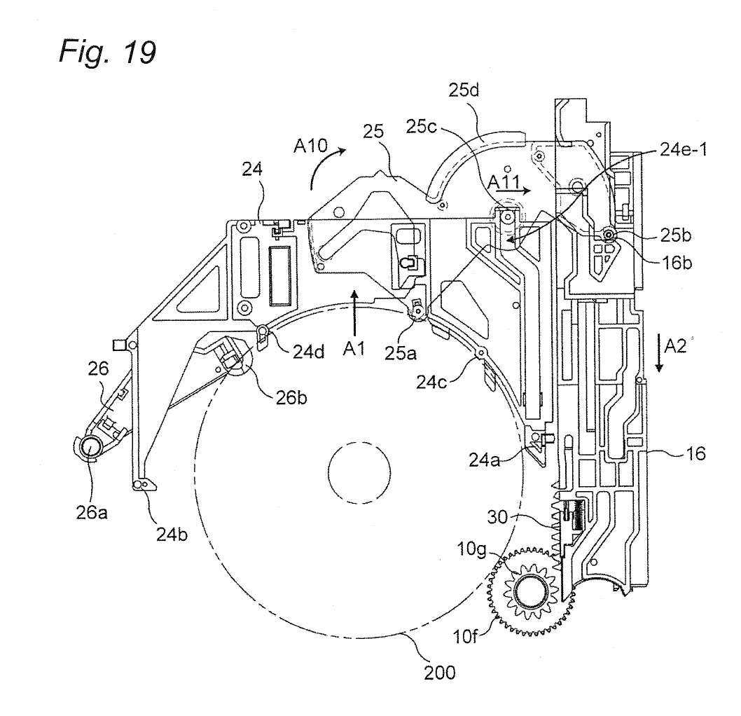

When the small-diameter disk 200 is further conveyed in the arrow A1 direction from the state shown in FIG. 18, the small-diameter disk 200 moves the centering member 24 in the arrow A1 direction against the bias force of the spring 24h, and also moves the guide lever 26 in the arrow A1 direction. Thereby, as shown in FIG. 19, the rotation shaft portion 25c of the trigger lever 25 moves into the first straight cam portion 24e-1 of the guide cam 24e, and the small-diameter disk 200 is contacted with the disk contact portion 25a of the trigger lever 25. It is noted that at this time point, the rack 30 of the slide cam member 16 and the pinion 10g are not yet meshed with each other.

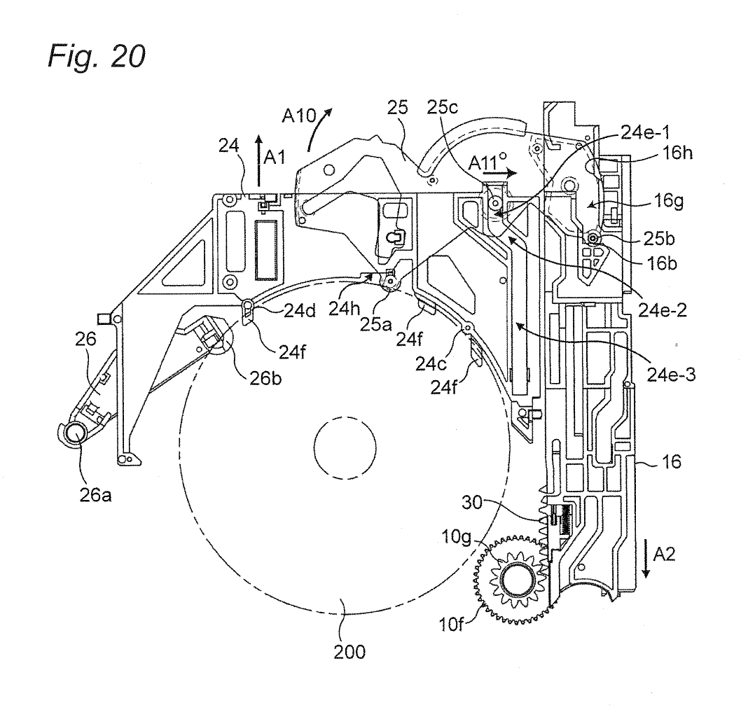

When the small-diameter disk 200 is further conveyed in the arrow A1 direction from the state shown in FIG. 19, the trigger lever 25 is pressed by the small-diameter disk 200 in the arrow A1 direction. At this time, since the rotation shaft portion 25c of the trigger lever 25 is engaged with the axial hole 22g (refer to FIGS. 9 and 10), the movement in the disk conveying direction is regulated. Moreover, since the rotation shaft portion is placed in the first straight cam portion 24e-1 (first position), the movement in the arrow A11 direction and the opposite direction thereof is regulated. Meanwhile, the centering member 24 is pressed by the small-diameter disk 200 and moved in the arrow A1 direction. Thereby, the trigger lever 25 pressed by the small-diameter disk 200 is rotated in the arrow A10 direction by the rotation shaft portion 25c. By this rotation of the trigger lever 25, the slide cam pressing portion 25b presses the first engagement portion 16b of the slide cam member 16 in the arrow A2 direction. Thereby, the entire slide cam member 16 slides in the arrow A2 direction, and as shown in FIG. 20, the rack 30 of the slide cam member 16 and the pinion 10g are meshed with each other. Thereby, the conveyance operation of the small-diameter disk 200 is completed, and the installment operation thereof is started. It is noted that in the state shown in FIG. 20, the small-diameter disk 200 is already conveyed to the replayable position.

Since the drive force of the motor 9 is transmitted via the gear row 10 and thus the pinion 10g is rotated in the state shown in FIG. 20, the meshed rack 30 is driven, and the slide cam member 16 further slides in the arrow A2 direction. In accordance with this sliding, the slide cam member 18 connected to the slide cam member 16 via the link arm 17 slides in the arrow A1 direction. By this sliding of the slide cam members 16, 18 in the opposite directions to each other, as described above, the installment operation of the small-diameter disk 200 onto the turntable 13 is performed. By the sliding of the slide cam member 16 in the arrow A2 direction, the first engagement portion 16b is brought away from the slide cam pressing portion 25b, and the slide cam pressing portion 25b is guided and moved by the cam portion 16g.

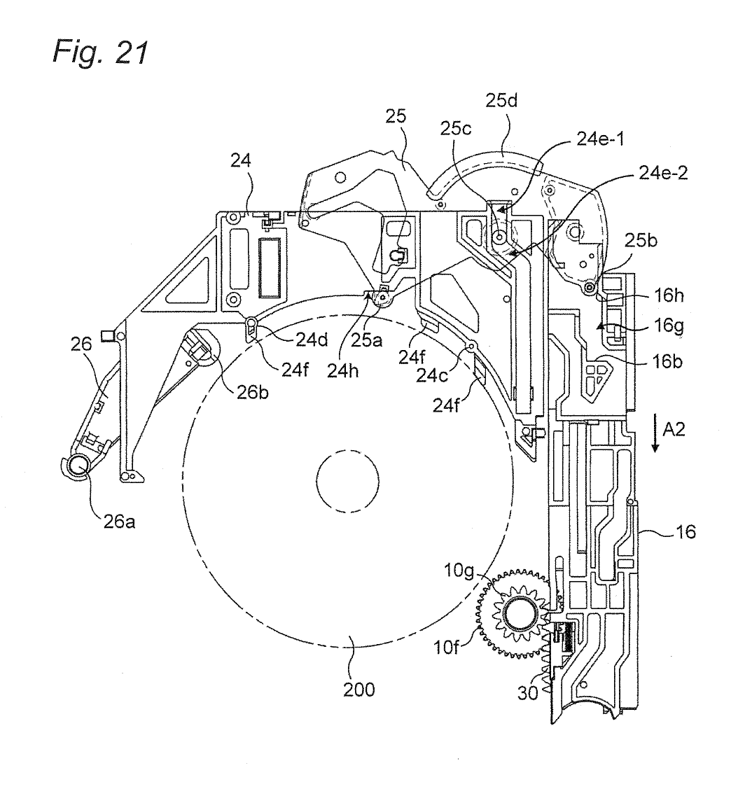

When the slide cam member 16 further slides in the arrow A2 direction from the state that the slide cam pressing portion 25b is placed in the cam portion 16g, the slide cam pressing portion 25b moves from the cam portion 16g to the position 25b-7 shown in FIG. 17 above the cam portion 16h via an tilt part. At this time, the trigger lever 25 is slightly rotated in the arrow A10 direction about the rotation shaft portion 25c. By this rotation, the edge portion 24h of the centering member 24 contacted with the disk contact portion 25a of the trigger lever 25 is pressed by the disk contact portion 25a, and the centering member 24 slides in the arrow A1 direction. Thereby, as shown in FIG. 21, the positioning contact portions 24c, 24d and the positioning guides 24f of the centering member 24, the disk contact portion 25a of the trigger lever 25, and the positioning guide 26b of the guide lever 26 are brought away from the small-diameter disk 200, and hence rotation of the small diameter disk 200 is not disturbed.

As described above, the installment operation of the small-diameter disk 200 is completed.

In the conveyance operation of the small-diameter disk 200, the distance between the position at which the disk is contacted with the positioning contact portions 24c, 24d of the centering member 24 and the replayable position to which the disk is conveyed is shorter than the distance in the conveyance operation of the large-diameter disk 100. Therefore, the rotation shaft portion 25c of the trigger lever 25 is not moved into the tilt cam portion 24e-2 of the guide cam 24e but moved only in the first straight cam portion 24e-1.

FIG. 22 is a view showing a positional relationship of the slide cam member 16, the centering member 24, and the trigger lever 25 relative to the large-diameter disk 100 conveyed to the replayable position, and a positional relationship of the slide cam member 16, the centering member 24, and the trigger lever 25 relative to the small-diameter disk 200 conveyed to the replayable position. In FIG. 22, the center of the large-diameter disk 100 and the center of the small-diameter disk 200 are placed on a straight line 21b orthogonal to the disk conveying direction, the straight line running through the center of the turntable 13. As clear from FIG. 22, even in the case where any of the large-diameter disk 100 and the small-diameter disk 200 is inserted into the casing 300, the slide cam member 16 can be slid in the arrow A2 direction by the slide cam pressing portion 25b of the trigger lever 25.

Next, with reference to FIGS. 23 to 27, configuration for raising and lowering the turntable 13 will be described in more detail.

FIG. 23 is a perspective view of the slide cam member 16. As described above, the raising and lowering cam 16a to be engaged with the engagement pin 19c provided to the intermediate chassis 19 in order to raise and the lower the front part of the intermediate chassis 19 is formed in the slide cam member 16. This raising and lowering cam 16a is formed by a lower surface cam portion 16a-1, a tilt cam portion 16a-2, and a higher surface cam portion 16a-3. The lower surface cam portion 16a-1 is a part for retaining the front part of the intermediate chassis 19 in a state that the front part is lowered. The tilt cam portion 16a-2 is a part for raising and lowering the front part of the intermediate chassis 19. The higher surface cam portion 16a-3 is a part for retaining the front part of the intermediate chassis 19 in a state that the front part is raised.

As shown in FIG. 2, the raising and lowering cam 18a to be engaged with the engagement pin 19d of the intermediate chassis 19 is formed to the slide cam member 18. This raising and lowering cam 18a is formed by a lower surface cam portion, a tilt cam portion, and a higher surface cam portion similarly to the slide cam member 16. The cam portions of the raising and lowering cam 18a and the cam portions 16a-1 to 16a-3 of the raising and lowering cam 16a have the opposite tilt directions to each other.

Accordingly, the slide cam member 16 and the slide cam member 18 slide in the opposite directions to each other as described above in a state that the engagement pin 19c is engaged with the raising and lowering cam 16a and the engagement pin 19d is engaged with the raising and lowering cam 18a, so that the front part of the intermediate chassis 19 is raised or lowered. That is, the turntable 13 provided in the front part of the intermediate chassis 19 is raised by the sliding of the slide cam member 16 in the arrow direction A2 and lowered by the sliding of the slide cam member 16 in the arrow A1 direction.

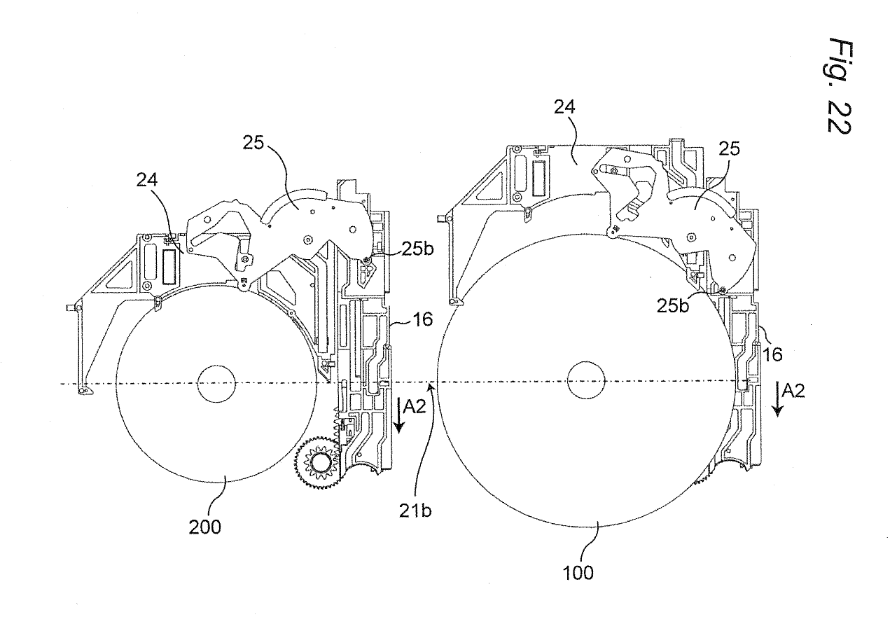

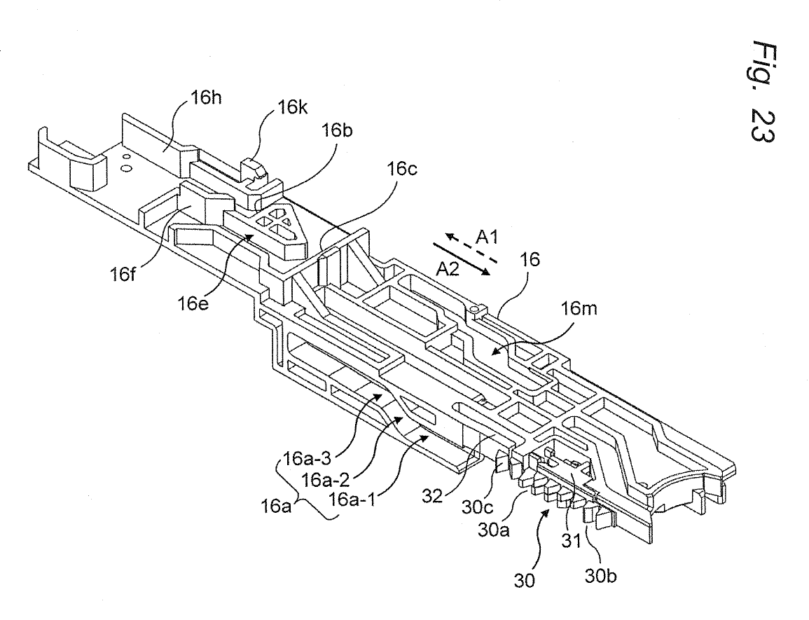

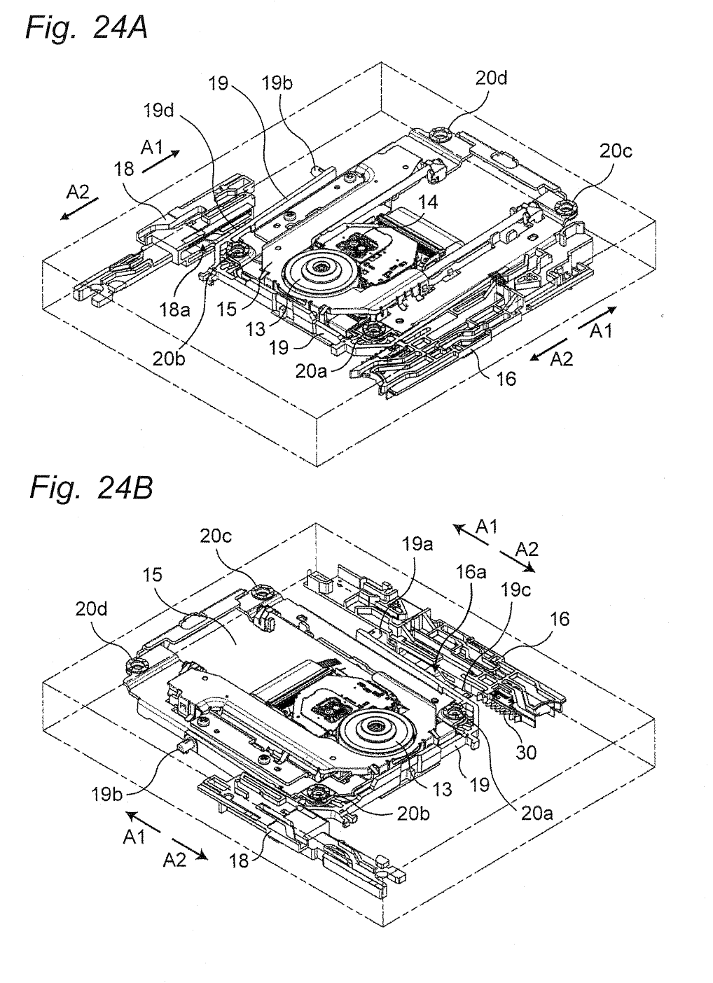

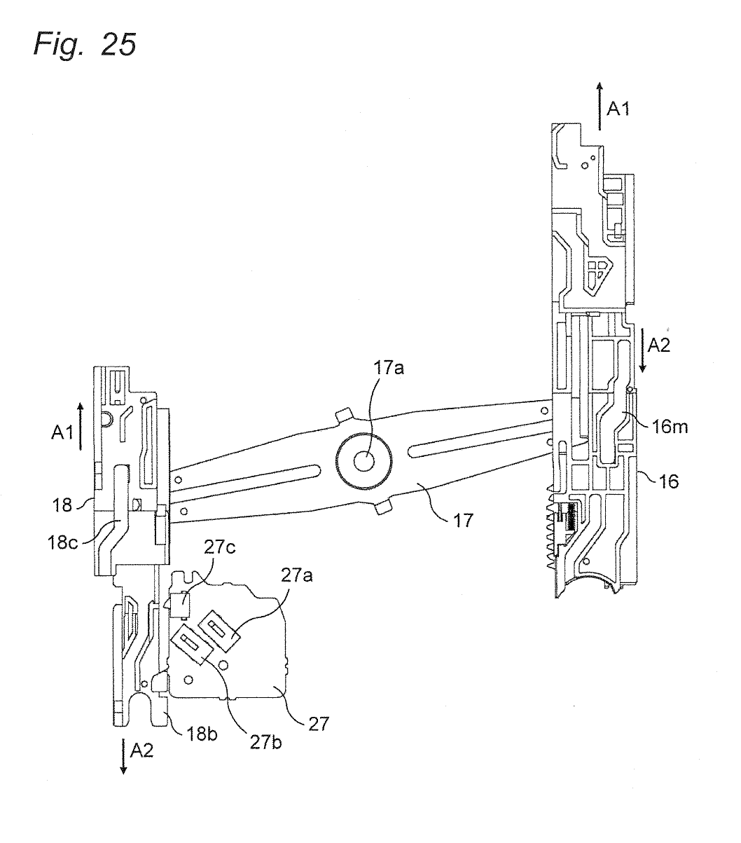

FIGS. 24A and 24B are perspective views showing a positional relationship between the intermediate chassis 19 and the slide cam members 16, 18 when the turntable 13 is lowered (standby state that the disk is not inserted). FIG. 25 is a top view showing a positional relationship between the slide cam members 16, 18 and the link arm 17 when the turntable 13 is lowered. In this state, the slide cam member 16 is biased in the A1 direction by the spring 16j as described above with reference to FIG. 3. This slide cam member 16 is coupled to the slide cam member 18 via the link arm 17. The link arm 17 is provided rotatably about a rotation shaft 17a. Therefore, the slide cam member 18 is biased by the spring 16j in the arrow A2 direction opposite to that of the slide cam member 16. In this state, since the turntable 13 is lowered, the disk can be inserted.

As shown in FIG. 25, a protruding portion 18b capable of being contacted with the detection switch 27c is formed to the slide cam member 18. When the disk is conveyed to the replayable position and the slide cam member 18 slides in the arrow A1 direction, the protruding portion 18b is contacted with the detection switch 27c so as to operate the detection switch 27c.

It is noted that as described above, the state shown in FIGS. 24A, 24B, and 25 is continued until the disk is conveyed to the replayable position, the slide cam member 16 is pressed by the slide cam pressing portion 25b of the trigger lever 25, the rack 30 is meshed with the pinion 10g, and then the slide cam member 16 starts sliding in the arrow A2 direction. The slide cam member 16 slides in the arrow A2 direction and the slide cam member 18 slides in the arrow A1 direction, so that the engagement pins 19c, 19d of the intermediate chassis 19 move along the raising and lowering cam 16a and the raising and lowering cam 18a. Thereby, the front part of the intermediate chassis 19 is raised, the turntable 13 is raised, and the disk is nipped between the turntable and the clamper 21. After that, the protruding portion 18b of the slide cam member 18 described above is contacted with the detection switch 27c, so that the drive of the motor 9 is stopped. Thereby, the disk is brought into an installment completion state.

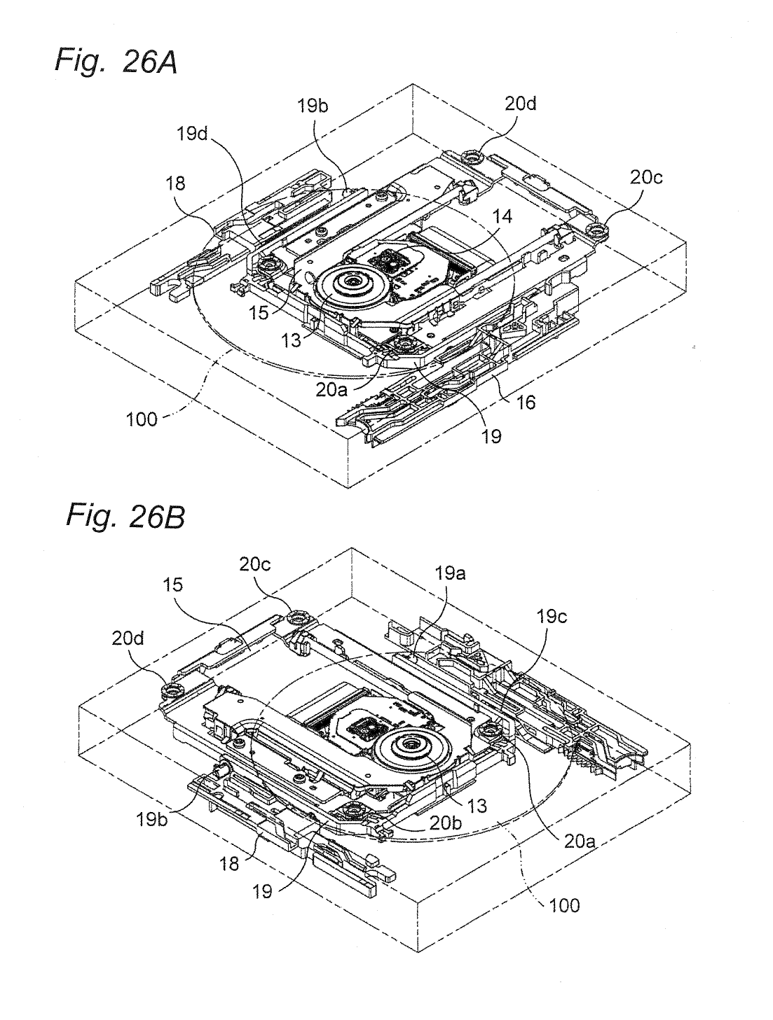

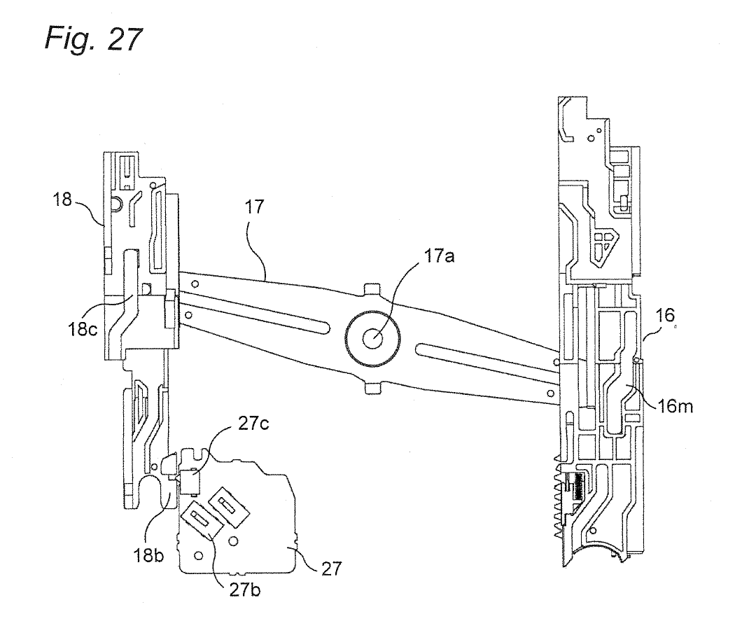

FIGS. 26A and 26B are perspective views showing a positional relationship between the intermediate chassis 19 and the slide cam members 16, 18 when the turntable 13 is raised (installment completion state of the disk: refer to FIG. 16 for the large-diameter disk 100, and refer to FIG. 21 for the small-diameter disk 200). FIG. 27 is a top view showing a positional relationship among the slide cam member 16, the slide cam member 18, and the link arm 17 when the turntable 13 is raised. It is noted that at this time, the rack 30 and pinion 10g remain being meshed with each other. This state is continued until the motor 9 is reversely driven by an ejecting operation for the disk ejection and the slide cam member 16 moves in the arrow A1 direction opposite to that of the disk conveyance.

It is noted that as shown in FIG. 23, an engagement portion 16k supporting the spring 16j for biasing the slide cam member 16 in the arrow A1 direction is formed in the slide cam member 16. A cam groove 16m for moving the clamper lifter 23a is formed on the upper surface of the slide cam member 16. Similarly, as shown in FIGS. 25 and 27, a cam groove 18c for moving the clamper lifter 23b is formed on the upper surface of the slide cam member 18.

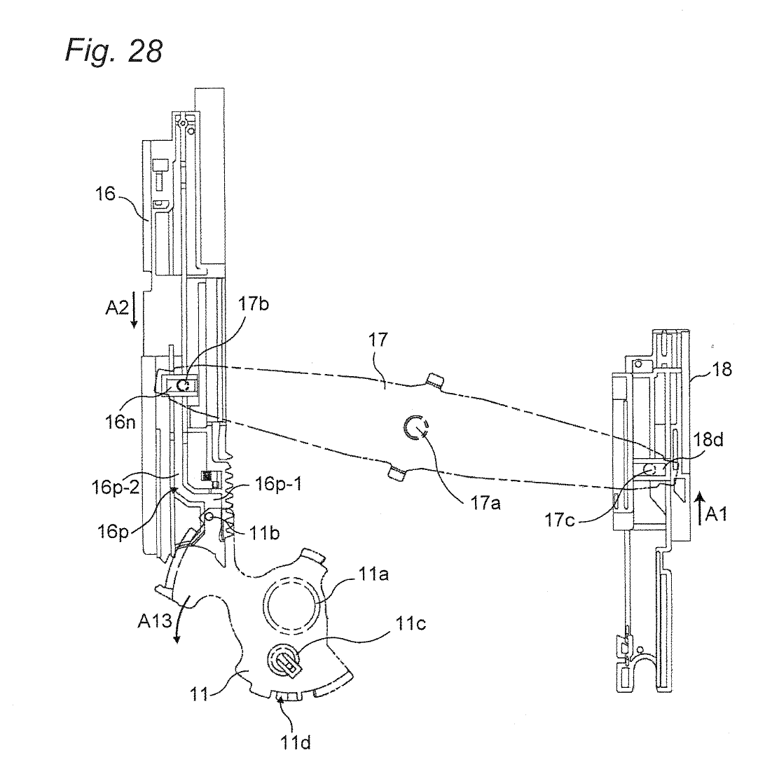

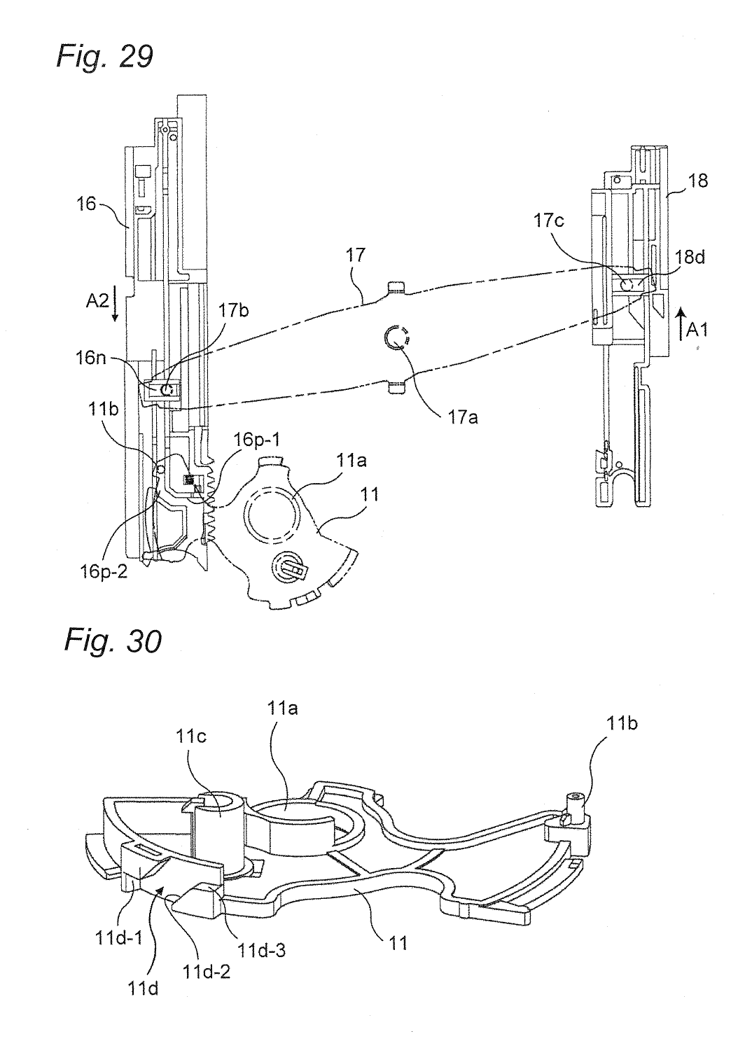

FIG. 28 is a bottom view showing a positional relationship among the slide cam members 16, 18, the link arm 17, and the clutch plate 11 when the turntable 13 is lowered. FIG. 29 is a bottom view showing a positional relationship among the slide cam members 16, 18, the link arm 17, and the clutch plate 11 when the turntable 13 is raised. As shown in these figures, engagement pins 17b, 17c are formed at both ends of the link arm 17. The engagement pin 17b is engaged with an engagement concave portion 16n formed in the slide cam member 16, and the engagement pin 17c is engaged with an engagement concave portion 18d formed in the slide cam member 18. Thereby, the link arm 17 couples the slide cam members 16, 18 so that these slide cam members are operated in association with each other. It is noted that the engagement pins 17b, 17c of the link arm 17 move while following an arc shape about the rotation shaft 17a, whereas the slide cam members 16, 18 move in a straight line in the arrow A1 or A2 direction. That is, in accordance with the rotation of the link arm 17, the distance between the rotation shaft 17a of the link arm 17 and the engagement concave portions 16n, 18d is hanged. Therefore, the engagement concave portions 16n, 18d are formed into a groove shape elongated at right angle to the arrow A1 and A2 directions so that the rotation of the link arm 17 is not prevented by the change in the distance.

As shown in FIGS. 28 and 29, a cam 16p is formed on the lower surface of the slide cam member 16 so as to rotate the clutch plate 11 in association with the sliding of the slide cam member 16. This cam 16p is formed by a first cam portion 16p-1 and a second cam portion 16p-2. The first cam portion 16p-1 is formed and extended at right angle to the sliding direction (arrow A1 or A2 direction) of the slide cam member 16. The second cam portion 16p-2 is extended in the sliding direction of the slide cam member 16 and formed so as to be coupled to the first cam portion 16p-1.

FIG. 30 is a perspective view of the clutch plate 11 seen from the upper side. The clutch plate 11 is provided with a bearing portion 11a rotatably supported on a shaft formed to the mechanical chassis 12, an engagement pin 11b to be engaged with the cam 16p of the slide cam member 16, a shaft portion 11c for rotatably supporting the gear 10c, and a cam 11d for raising and lowering a disk insertion blocking member 33. The clutch plate 11 is rotatable in a state that the bearing portion 11a is arranged coaxially with a rotation axis of the gear 10d for transmitting the drive force of the motor 9, and the gear 10c is rotatably supported by a periphery of the shaft portion 11c. The cam 11d has a lower surface cam portion 11d-1, a tilt cam portion 11d-2, and an upper surface cam portion 11d-3.

The slide cam member 16 slides in a state that the engagement pin 11b is engaged with the cam 16p of the slide cam member 16, so that the clutch plate 11 is rotated. That is, the slide cam member 16 slides in the arrow A2 direction from the state shown in FIG. 28, so that the engagement pin 11b is contacted with the first cam portion 16p-1. When the slide cam member 16 further slides in the arrow A2 direction from this state, the clutch plate 11 is rotated in an arrow A13 direction about the bearing portion 11a, and the engagement pin 11b moves from the first cam portion 16p-1 to the second cam portion 16p-2. Thereby, the rotation of the clutch plate 11 is stopped. When the slide cam member 16 further slides in the arrow A2 direction from this state, the engagement pin 11b is guided and moved by the second cam portion 16p-2. FIG. 29 shows a state that the disk installment operation described above is completed and the sliding of the slide cam member 16 is stopped. In this state, the engagement pin 11b is retained by the second cam portion 16p-2, and the rotation of the clutch plate 11 is regulated.

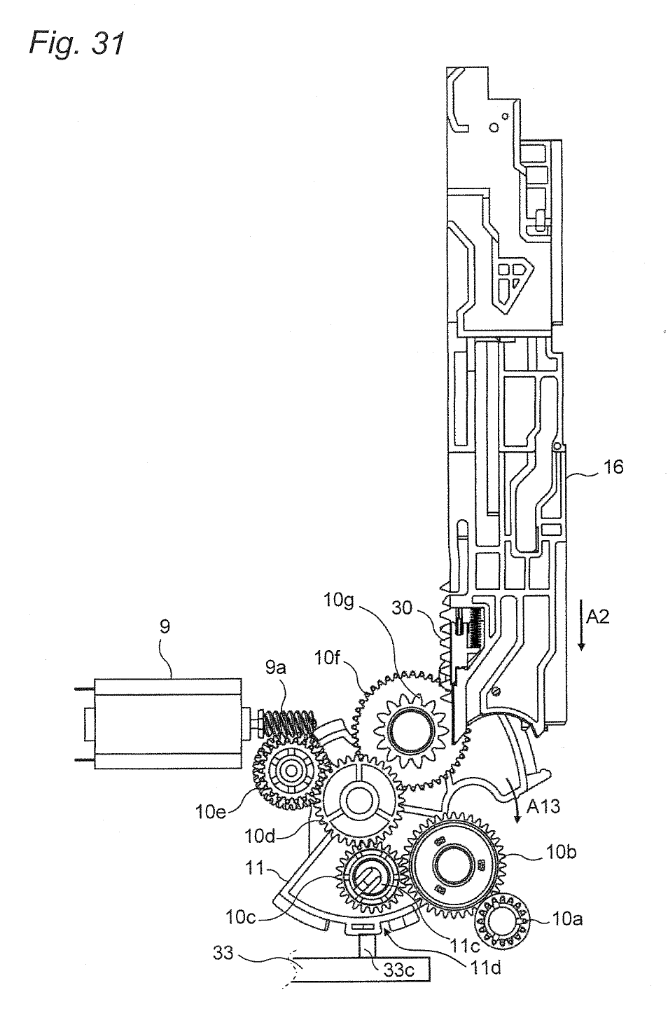

Next, with reference to FIGS. 31 to 33, an operation for switching the transmission route of the drive force of the motor 9 by rotating the clutch plate 11, that is, an operation for switching the disk conveyance operation and the disk installment operation will be described.

FIG. 31 is a top view showing a positional relationship of the parts relating to the clutch plate before the disk conveyance operation. In the state shown in FIG. 31, the drive force of the motor 9 can be transmitted to the gear 10a via the worm gear 9a, the gear 10e, the gear 10d, the gear 10c, and the gear 10b. As described above with reference to FIGS. 2 and 7, the gear 10a can transmit the drive force of the motor 9 to the roller gears 6e, 6f integrated with the rubber rollers 6a, 6b via the gear row 8. Meanwhile, in this state, the gear 10f is meshed with the lower portion of the gear 10d so as to transmit the drive force. However, the pinion 10g integrated with the gear 10f is not meshed with the rack 30.

When the motor 9 is driven in the state shown in FIG. 31, the drive force of the motor 9 is transmitted to the roller gears 6e, 6f, so that the rubber rollers 6a, 6b are rotated. By this rotation of the rubber rollers 6a, 6b, the disk can be conveyed to the replayable position. At this time, the drive force of the motor 9 functions as disk conveying force. At this time, the drive force of the motor 9 is also transmitted to the pinion 10g and the pinion is rotated. However, the pinion is not yet meshed with the rack 30.

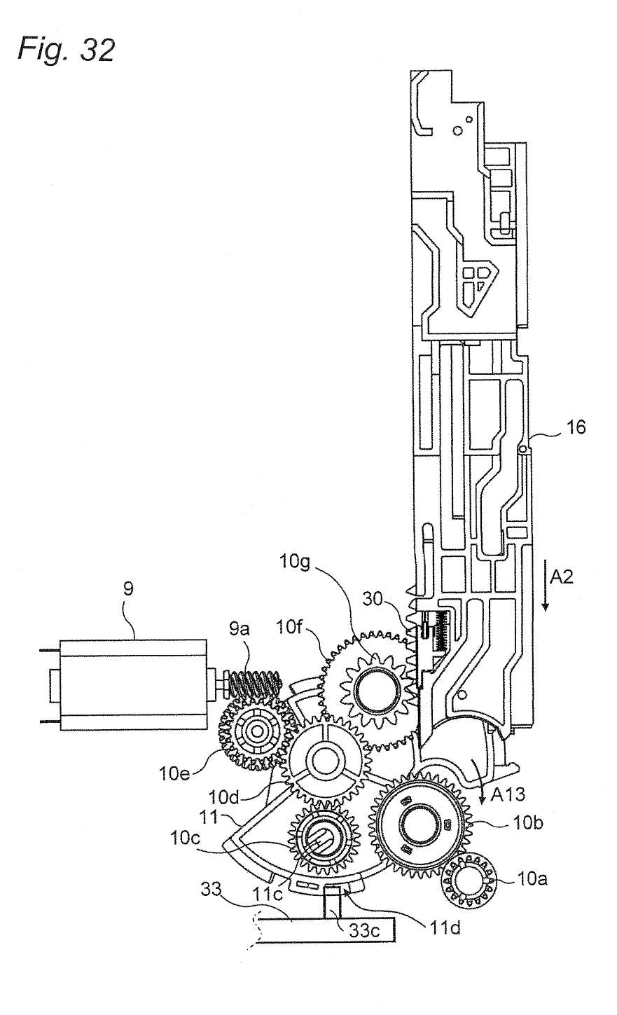

When the disk is conveyed in the arrow A1 direction to the replayable position, as described above, the slide cam member 16 slides in the arrow A2 direction. Thereby, the rack 30 and the pinion 10g are meshed with each other. At this time, since the drive force of the motor 9 is transmitted to the pinion 10g and the pinion is rotated, the slide cam member 16 further slides in the arrow A2 direction. By this sliding of the slide cam member 16, the clutch plate 11 is rotated in the arrow A13 direction as described above with reference to FIGS. 28 and 29. By this rotation, the gear 10c provided on the clutch plate 11 moves in the arrow A13 direction at the same time. Thereby, as shown in FIG. 32, meshing between the gear 10b provided on the mechanical chassis 12 and the gear 10c is released, so that the rotation of the rubber rollers 6a, 6b is stopped.

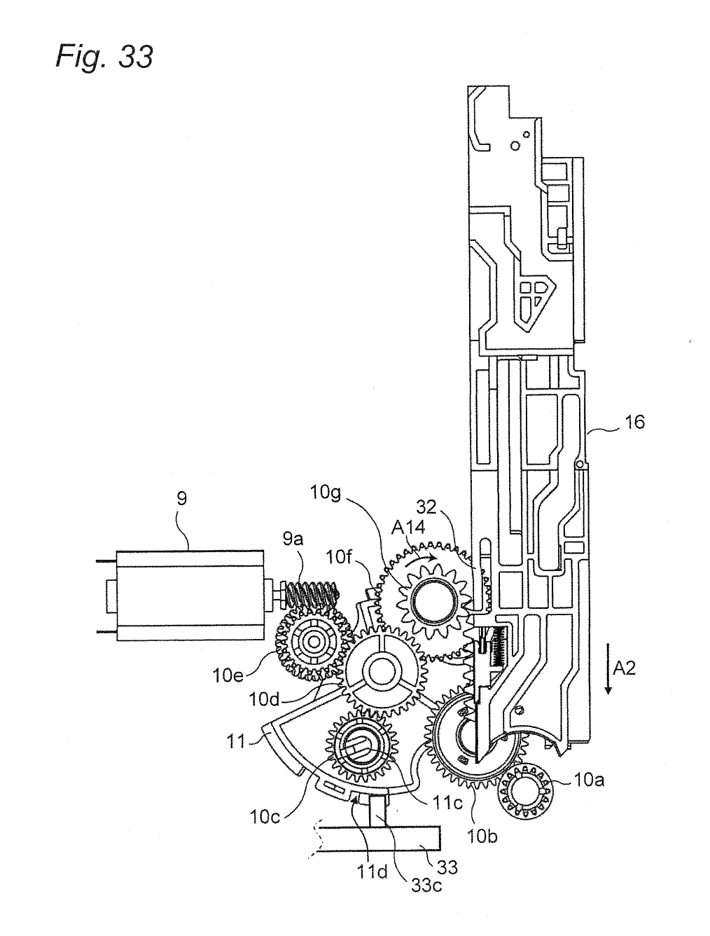

FIG. 32 is a top view showing a positional relationship of the parts relating to the clutch plate during the disk installment operation. At this time, the drive force of the motor 9 is transmitted only to the pinion 10g via the worm gear 9a, the gear 10e, the gear 10d, and the gear 10f. When the slide cam member 16 further slides in the A2 direction by the rotation of the pinion 10g meshed with the rack 30, as described above, the engagement pin 11b of the clutch plate 11 moves to the second cam portion 16p-2 of the cam 16p, so that the rotation of the clutch plate 11 is regulated. In the state that the engagement pin 11b is placed in the second cam portion 16p-2, further movement of the slide cam member 16 in the A2 direction is allowed. When the slide cam member 16 slides to the position shown in FIG. 29, the drive of the motor 9 is stopped. In this process of rotating the clutch plate 11 from this first cam portion 16p-1 to the second cam portion 16p-2, the disk is installed onto the turntable 13 and is brought into the installment completion state shown in FIG. 33.

FIGS. 33, 26, and 27 show a state after completion of the same disk installment operation. In this state, meshing between the pinion 10g and the rack 30 is retained. This state is maintained until the motor 9 is reversely driven for the disk ejection and the drive force in the opposite direction to that of the conveyance of the disk is transmitted to the rack 30. It is noted that the clutch plate 11 shown in FIG. 33 is slightly rotated in the arrow A13 direction in comparison to the state of FIG. 32.

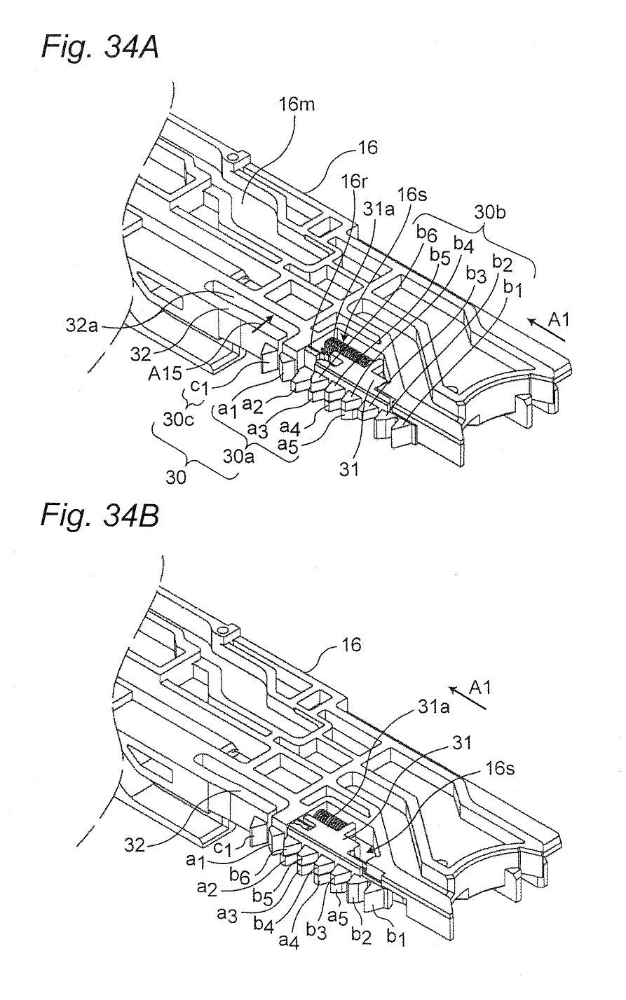

Next, with reference to FIGS. 34A and 34B, a configuration of the rack 30 will be described in detail. FIGS. 34A and 34B are perspective views showing the configuration of the rack 30. The rack 30 is formed by a main body rack 30a integrated with the slide cam member 16, a buffer rack 30b formed in an auxiliary rack body 31, and an elastic rack 30c formed in an elastic arm 32. The main body rack 30a, the buffer rack 30b, and the elastic rack 30c have functions different from each other at the time of transmitting the drive force of the motor 9 from the pinion 10g. The main body rack 30a, the buffer rack 30b, and the elastic rack 30c are formed so that arrangement pitches of teeth thereof are the same as each other.

The main body rack 30a is integrated with a main body of the slide cam member 16. The main body rack 30a is a major part for transmitting the drive force of the motor 9 to the slide cam member 16. The main body rack 30a is provided with rack teeth a1 to a5. The rack teeth a2 to a5 are formed so that the width in the thickness direction is smaller than (e.g. ½ of) the rack tooth a1 placed on the most upstream side in the arrow A2 direction (first rack tooth to be meshed with the tooth of the pinion 10g at the time of performing the ejection from the state that the disk is installed in FIG. 33). As shown in FIGS. 34A and 34B, the rack teeth a2 to a5 are formed on the rather lower side. The rack tooth a1 and the rack tooth a5 arranged at both ends among the rack teeth a1 to a5 are formed into a steep mountain shape on top of which no flat part is formed. Thereby, at the beginning of meshing between the pinion 10g and the rack 30, top parts of the teeth provided in the pinion and the rack are contacted with each other, and reactive force thereof prevents disturbance of the rotation of the pinion 10g.

In the vicinity of the main body rack 30a, a rib portion 16r is provided so as to be extended in the disk conveying direction (A1 or A2 direction). The auxiliary rack body 31 is slidably fitted to this rib portion 16r. The auxiliary rack body 31 is biased in the arrow A2 direction by a spring 31a serving as one example of an elastic member provided in a space 16s formed in the slide cam member 16. The buffer rack 30b described above is formed in this auxiliary rack body 31, and the buffer rack 30b is provided with rack teeth b1 to b6. The rack teeth b3 to b6 are formed so that the width in the thickness direction is smaller than (e.g. 1.2 of) the rack tooth b1 and the rack tooth b2 placed on the downstream side in the arrow A2 direction. As shown in FIGS. 34A and 34B, the rack teeth b3 to b6 are formed on the rather upper side. The rack tooth b1 and the rack tooth b6 arranged at both ends among the rack teeth b1 to b6 are formed into a steep mountain shape on top of which no flat part is formed. Thereby, at the beginning of meshing between the pinion 10g and the rack 30, the top parts of the teeth provided in the pinion and the rack are contacted with each other, and the reactive force thereof prevents the disturbance of the rotation of the pinion 10g.

When the auxiliary rack body 31 is biased in the arrow A2 direction by the spring 31a as shown in FIG. 34A, the rack teeth b4 to b6 and the rack teeth a3 to a5 are arranged so as to face each other in the thickness direction of the rack 30. That is, in this case, the rack tooth b4 and the rack tooth a5, the rack tooth b5 and the rack tooth a4, and the rack tooth b6 and the rack tooth a3 are respectively overlapped with each other, so that three rack teeth having the substantially same size as the rack teeth a1, b1, b2 are formed. In other words, the thickness of the rack teeth a1, b1, b2 is formed to be, for example, the sum of the thickness of the rack tooth b4 and the thickness of the rack tooth a5. In the state that the auxiliary rack body 31 moves in the arrow A1 direction against bias force of the spring 31a and contacted with an end of the rib portion 16r as shown in FIG. 34B, the rack teeth b3 to b6 and the rack teeth a2 to a5 are arranged so as to face each other in the thickness direction of the rack 30. That is, in this case, the rack tooth b3 and the rack tooth a5, the rack tooth b4 and the rack tooth a4, the rack tooth b5 and the rack tooth a3, and the rack tooth b6 and the rack tooth a2 are respectively overlapped with each other, so that four rack teeth having the substantially same size as the rack tooth a1, b1, or b2 are formed. That is, the spring 31a is elastically deformed, so that the auxiliary rack body 31 in which the buffer rack 30b is formed is moved by one pitch for the rack teeth of the main body rack 30a.

The elastic rack 30c is provided to the elastic arm 32 formed to the slide cam member 16. The elastic arm 32 is deformable in the direction in which the elastic arm is brought away from the pinion 10g. The elastic rack 30c is provided with a rack tooth c1 serving as the tooth on the most upstream side in the arrow A2 direction of the rack 30. The rack tooth c1 is formed into a steep mountain shape on top of which no flat part is formed similarly to the rack tooth a1 of the main body rack 30a. Thereby, at the beginning of meshing between the pinion 10g and the rack 30, the top parts of the teeth provided in the pinion and the rack are contacted with each other, and the reactive force thereof prevents the disturbance of the rotation of the pinion 10g.

In a case of driving due to a time lag from a stop command of the motor 9 to be stopped at the time point of disk installment completion to actual stoppage, or in a case of driving without stopping the motor 9 due to some troubles or the like, when the rotation force is transmitted to the pinion 10g, the rack tooth c1 functions to release the meshing between the pinion 10g and the rack 30. For example, when the pinion 10g is further rotated in an arrow A14 direction in the state of the disk installment completion as shown in FIG. 33, the elastic arm 32 is deformed toward a space 32a shown in FIG. 34A, that is, in an arrow A15 direction so that the top part of the tooth of the pinion 10g and the top part of the rack tooth c1 are contacted with each other. Thereby, the meshing between the tooth of the pinion 10g and the rack tooth c1 is released. When the pinion 10g is further rotated in the arrow A14 direction from this state, the tooth of the pinion 10g and the rack tooth c1 are meshed with each other. This state that the meshing between the tooth of the pinion 10g and the rack tooth c1 is released and the state that the tooth of the pinion and the rack tooth are meshed with each other are alternately repeated until the rotation of the pinion 10g is stopped. With this configuration, when drive stoppage of the motor 9 is not normally performed and an excessive load is applied to the meshing part between the pinion 10g and the rack 30, effectively prevented is an accident such as breakage of the worm gear 9a, the gear row 10, or the rack 30 to which the drive force of the motor 9 is transmitted.

It is noted that a buffer portion for absorbing and reducing shock caused due to a speed difference or the like at the beginning of meshing between the pinion 10g and the rack 30 is formed by the auxiliary rack body 31 slidably formed to the slide cam member 16, the spring 31a for biasing the auxiliary rack body 31 in one direction, and the buffer rack 30b formed in the auxiliary rack body 31 in the first embodiment. It is noted that the buffer portion of the present invention is not limited to the above described configuration, needless to say.

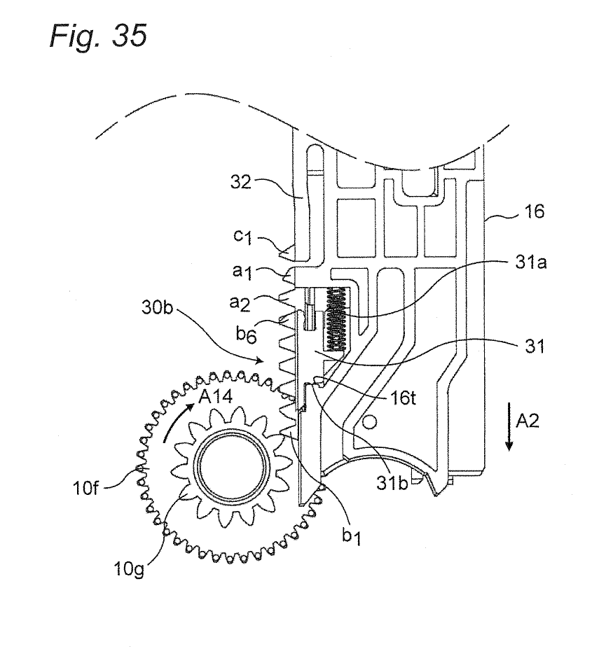

Next, with reference to FIGS. 35 to 37, effects such as prevention of the breakage of the parts by the auxiliary rack body 31, the spring 31a, and the buffer rack 30b will be described further in detail.

FIG. 35 is a top view showing a state at an instant when the slide cam member 16 slides in the arrow A2 direction and the rack tooth b1 of the buffer rack 30b is contacted with the tooth of the pinion 10g. In the state shown in FIG. 35, similarly to the state shown in FIG. 34A, the buffer rack 30b is biased in the arrow A2 direction by the spring 31a. In this state, the slide cam member 16 slides in the arrow A2 direction, and the pinion 10g is rotated in the arrow A14 direction, so that the rack 30 and the pinion 10g are meshed with each other. However, in a case where there is a difference between a sliding speed of the slide cam member 16 and a rotation speed of the pinion 10g, a case where a meshing relation between top lands and bottom lands of the teeth between the pinion 10g and the rack 30 is not smooth, or the like, the meshing between the rack 30 and the pinion 10g in particular is sometimes not favorably begun. In this case, there is caused the accident such as the breakage of the pinion 10g or the rack 30.

Meanwhile, in the first embodiment, the rack tooth to be meshed first with the tooth of the pinion 10g is the rack tooth b1 of the buffer rack 30b, so that the auxiliary rack body 31 in which the buffer rack 30b is formed can move in the arrow A1 direction against the bias force of the spring 31a. Thereby, at the beginning of meshing between the pinion 10g and the rack 30, the shock caused due to the speed difference between the pinion 10g and the rack 30 or the like can be absorbed and reduced, so that the accident such as the breakage of the pinion 10g or the rack 30 can be prevented.

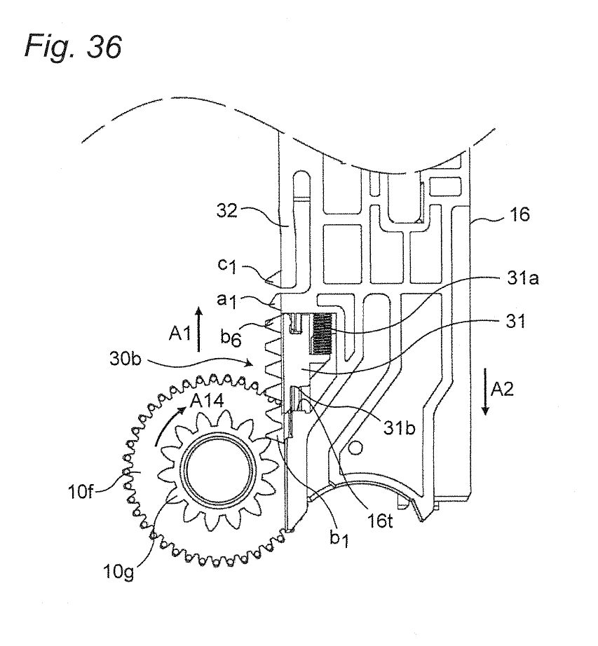

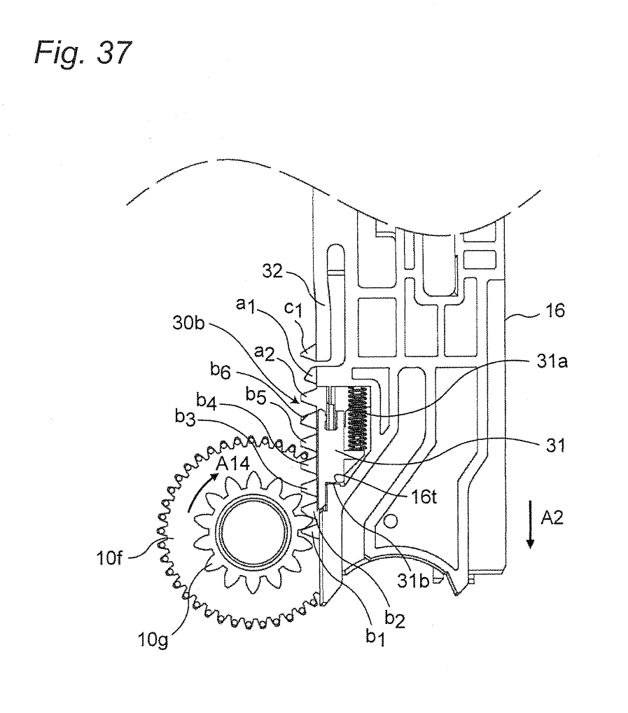

FIG. 36 is a top view showing a state at an instant when the auxiliary rack body 31 moves in the arrow A2 direction against the bias force of the spring 31a, so that collision between the rack tooth b1 of the buffer rack 30b and the tooth of the pinion 10g is absorbed, in a case where the moving speed of the slide cam member 16 is faster than the rotation speed of the pinion 10g. As shown in FIG. 36, a contacting surface 31b of the auxiliary rack body 31 is placed away from a level difference portion 16t forming the rib portion 16r of the slide cam member 16. At this time, the rack 30 is in the state shown in FIG. 34B. Since the pinion 10g is rotated by the drive of the motor 9 in this state, the tooth of the pinion 10g and the rack tooth b1 of the buffer rack 30b are meshed with each other at a next step, so that the auxiliary rack body 31 moves in the arrow A2 direction. Thereby, the contacting surface 31b of the auxiliary rack body 31 is contacted with the level difference portion 16t of the slide cam member 16. Such a contact state is shown in FIG. 37.

FIG. 37 is a top view showing a state at an instant when the rack teeth of the buffer rack 30b are meshed with the teeth of the pinion 10g and the slide cam member 16 starts sliding by the drive of this pinion 10g. In the state shown in FIG. 37, the teeth of the pinion 10g are meshed with the rack tooth b1 and the rack tooth b2 of the buffer rack 30. When the pinion 10g is rotated in this state, due to the contact of the contacting surface 31b of the auxiliary rack body 31 with the level difference portion 16t, the buffer rack 30b moves in the arrow A2 direction integrally with the slide cam member 16.

In a fixed period of transition from the state shown in FIG. 31 to the state shown in FIG. 32, the slide cam member 16 receives at the same time both rotation force of the trigger lever 25 rotated by being pressed by the disk and rotation force of the pinion 10g. In this period, the slide cam member 16 moves in the arrow A2 direction at a faster speed between a sliding speed due to the rotation force of the trigger lever 25 and a sliding speed due to the rotation force of the pinion 10g. In the above described period, the pinion 10g is meshed only with the buffer rack 30b of the auxiliary rack body 31. That is, the auxiliary rack body 31 is moved in the arrow A2 direction only due to the rotation force of the pinion 10g. Therefore, in a case where the sliding speed of the slide cam member 16 due to the rotation force of the trigger lever 25 is faster than the sliding speed of the slide cam member 16 due to the rotation force of the pinion 10g, a speed difference is caused between the moving speed of the slide cam member 16 and the moving speed of the auxiliary rack body 31 meshed with the pinion 10g. In a case where the auxiliary rack body 31 cannot move relatively to the slide cam member 16, an excessive load is applied to the meshing part between the pinion 10g and the rack 30 due to the speed difference, and there is a fear that the meshing part is broken. Even when the meshing part is not broken, the reactive force acting in the opposite direction of the sliding direction of the slide cam member 16 is transmitted to the disk via the slide cam member 16 and the trigger lever 25, so that the conveyance operation of the disk is disturbed. In this case, a load may be applied to the driving motor 9 or the rubber roller 6a for conveying the disk may spin around and thus the rubber roller 6a is worn.

Meanwhile, in the first embodiment, the auxiliary rack body 31 can move in the arrow A1 direction against the bias force of the spring 31a, so as to suppress that an excessive load is applied to the meshing part between the pinion 10g and the rack 30 due to the speed difference. A load applied to the motor 9 serving as the drive source can be reduced, and spinning-around of the rubber roller 6a for conveying the disk can be suppressed. Thus, wear of the rubber roller 6a can be reduced.

It is noted that in the above description, the spring 31a is elastically deformed, so that the buffer rack 30b is moved by one pitch for the rack teeth of the main body rack 30a. However, the present invention is not limited to this configuration. The auxiliary rack body 31 may slide at an integral-multiple of a stroke of the arrangement pitch for the rack teeth of the main body rack 30a. Also with this configuration, the shock caused at the beginning of meshing between the pinion 10g and the rack 30 can be effectively reduced.

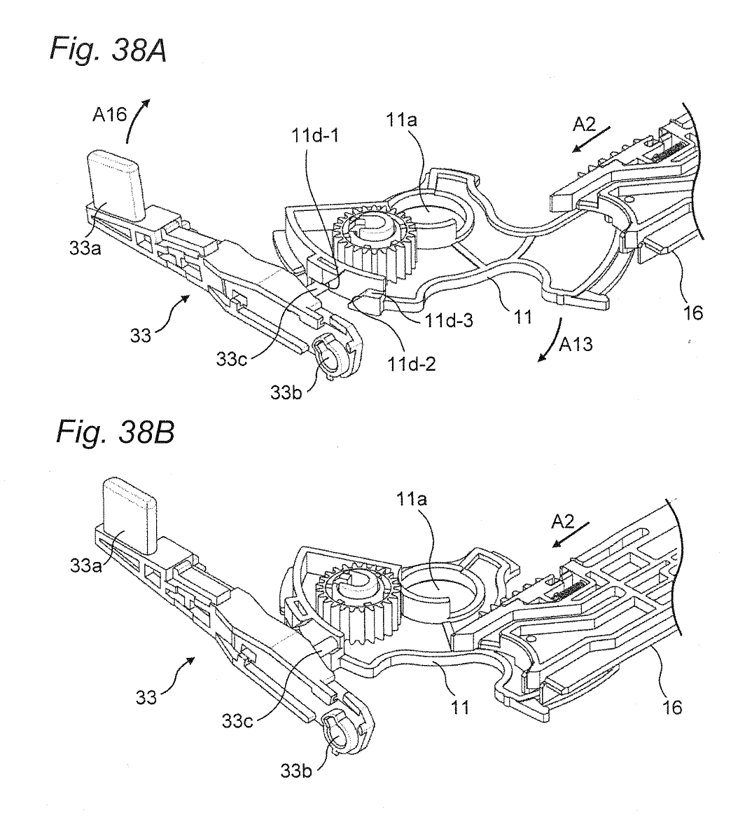

Next, with reference to FIGS. 38A and 38B, a relationship between the clutch plate 11 and the disk insertion blocking member 33 will be described. FIG. 38A is a perspective view showing a positional relationship between the disk insertion blocking member 33 and the clutch plate 11 when the disk insertion blocking member 33 is lowered. FIG. 38B is a perspective view showing a positional relationship between the disk insertion blocking member 33 and the clutch plate 11 when the disk insertion blocking member 33 is raised.

As clear from FIGS. 2 and 3, the disk insertion blocking member 33 is arranged in the vicinity of the opening portion 1a for the disk insertion and ejection. As shown in FIGS. 38A and 38B, the disk insertion blocking member 33 is provided with a blocking piece 33a for blocking the insertion of the disk at a front end thereof. The disk insertion blocking member 33 is provided with a rotation shaft 33b at the other end and attached so as to be rotatable about the rotation shaft 33b. The disk insertion blocking member 33 is provided with an engagement pin 33c to be engaged with the cam 11d of the clutch plate 11. As described with reference to FIG. 30, the cam 11d of the clutch plate 11 has the lower surface cam portion 11d-1, the tilt cam portion 11d-2, and the upper surface cam portion 11d-3.

In a state that the disk is not installed onto the turntable 13, the blocking piece 33a of the disk insertion blocking member 33 is lowered as shown in FIG. 38A. When the slide cam member 16 slides in the arrow A2 direction from the state shown in FIG. 38A and the clutch plate 11 is rotated in the arrow A13 direction, the engagement pin 33c is guided by the cam 11d, so that the disk insertion blocking member 33 is rotated in the arrow A16 direction about the rotation shaft 33b. FIG. 38B shows a state that the engagement pin 33c of the disk insertion blocking member 33 moves from the lower surface cam portion 11d-1 to the upper surface cam portion 11d-3 through the tilt cam portion 11d-2.

Timing of the state change of the disk insertion blocking member 33 from the state shown in FIG. 38A to the state shown in FIG. 38B is influenced by a rotating operation of the clutch plate 11 by the sliding of the slide cam member 16 described above with reference to FIGS. 31 to 33. The state of the engagement pin 33c is changed by the cam 11d as shown in FIGS. 31 to 33. FIG. 38B shows the state that the disk is installed onto the turntable 13. In the state that the disk insertion blocking member 33 is raised as shown in FIG. 38B, the disk insertion blocking member blocks insertion of another disk from the opening portion 1a into the casing 300.

With the disk device according to the first embodiment, the centering member 24 is provided movably in the disk conveying direction by the disk conveying force by the disk conveyance mechanism, and the rotation shaft portion 25c of the trigger lever 25 is movable in accordance with the movement of the centering member 24 in the conveying direction. By rotating the trigger lever 25 by the disk conveying force, the slide cam member 16 forming the disk installment mechanism is pressed so as to drive the disk installment mechanism. With this configuration, a series of operations of detecting the conveyed disk having a different diameter, placing the disk at the replayable position in accordance with the diameter of the disk so that the center of the disk faces the turntable 13, and driving the disk installment mechanism can be performed by three members of the trigger member 25, the centering member 24, and the slide cam member 16. Therefore, the number of parts can be further reduced.

With the disk device according to the first embodiment, the centering member 24 has the large-diameter disk positioning contact portions 24a, 24b and the small-diameter disk positioning contact portions 24c, 24d. Thereby, the large-diameter disk 100 and the small-diameter disk 200 can be more reliably conveyed to and placed at the replayable position so that the center of each disk faces the turntable 13.

With the disk device according to the first embodiment, the slide cam member 16 has the cam portion 16d between the first engagement portion 16b and the second engagement portion 16c. Thereby, when the large-diameter disk 100 is inserted into the casing 300 and the rotation shaft portion 25c of the trigger lever 25 moves, the slide cam pressing portion 25b can be rotated while the movement is not disturbed by the cam portion 16d.

With the disk device according to the first embodiment, the guide portion 24e formed in the centering member 24 has the first straight cam portion 24e-1, the tilt cam portion 24e-2, and the second straight cam portion 24e-3. Thereby, the position of the rotation shaft portion 25c of the trigger lever 25 can be reliably differentiated between the case where the large-diameter disk 100 is inserted into the casing 300 and the case where the small-diameter disk 200 is inserted into the casing 300 without increasing the number of parts.

### Second Embodiment

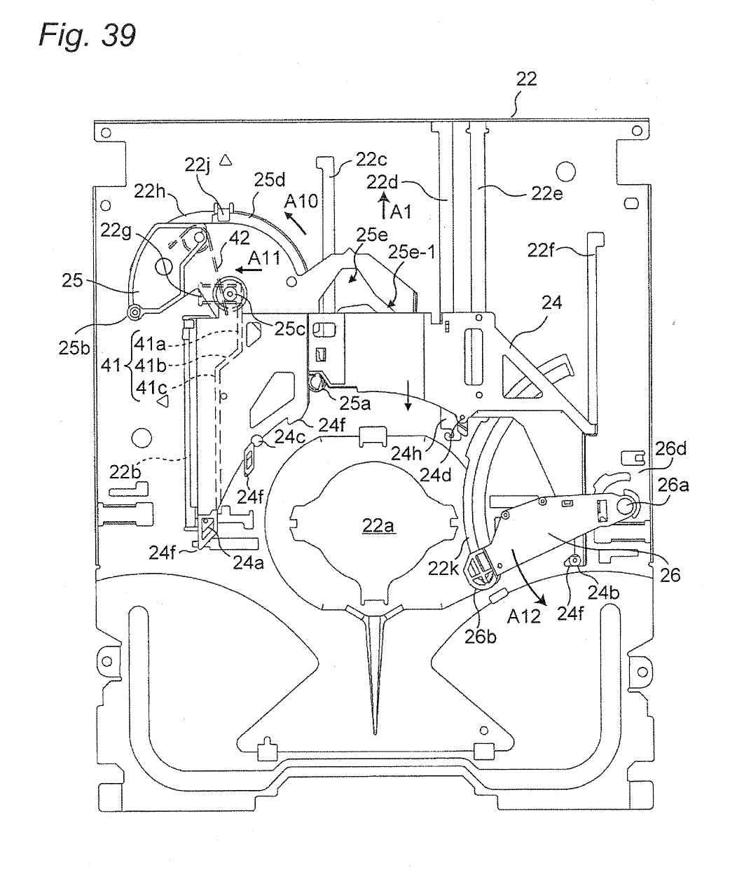

A disk device according to a second embodiment of the present invention will be described with reference to FIG. 39. FIG. 39 is a bottom view showing a state that the parts relating to the upper base 22 are attached to the upper base 22 in the disk device according to the second embodiment of the present invention. A different point of the disk device according to the second embodiment from the disk device according to the first embodiment is that in place of the guide cam 24e (refer to FIG. 10), a guide rib 41 and a twist spring 42 serving as one example of a biasing member are provided as guide portions for guiding the movement of the rotation shaft portion 25c of the trigger lever 25.

The guide rib 41 has a first straight guide portion 41a and a second straight guide portion 41c provided in parallel to the disk conveying direction, and a tilt guide portion 41b provided in the crossing direction to the disk conveying direction to couple the first straight guide portion 41a and the second straight guide portion 41c. The twist spring 42 is provided so as to bias the rotation shaft portion 25c of the trigger lever 25 so that the rotation shaft portion is contacted with the guide rib 41. With this configuration, the rotation shaft portion 25c of the trigger lever 25 engaged with the axial hole 22g formed in the upper base 22 so that the movement in the disk conveying direction is regulated slides along the guide rib 41 when the centering member 24 moves in the disk conveying direction. That is, the rotation shaft portion 25c moves in the arrow A11 direction when the centering member 24 moves in the arrow A1 direction.

Next, functions of the guide rib 41 and the twist spring 42 when the large-diameter disk 100 is inserted into the casing 300 will be described.

As described above with reference to FIG. 12, the large-diameter disk 100 inserted into the casing 300 is contacted with the positioning contact portions 24a, 24b of the centering member 24. At this time, the rotation shaft portion 25c of the trigger lever 25 is placed above the first straight guide portion 41a (first position) as shown in FIG. 39.

After that, when the large-diameter disk 100 is further conveyed in the arrow A1 direction, the centering member 24 is pressed by the large-diameter disk 100 so as to move in the arrow A1 direction. At this time, the rotation shaft portion 25c is engaged with the axial hole 22g (refer to FIGS. 9 and 10) so that the movement in the arrow A1 direction is regulated, and biased in the opposite direction to the arrow A11 direction by the twist spring 42. Thus, the rotation shaft portion slides along the first straight guide portion 41a.

After that, when the large-diameter disk 100 is further conveyed in the arrow A1 direction, the rotation shaft portion 25c is guided by the tilt guide portion 41b so as to move in the arrow A11 direction in the axial hole 22g. Thereby, the entire trigger lever 25 including the slide cam pressing portion 25b moves in the arrow A11 direction.

After that, when the large-diameter disk 100 is further conveyed in the arrow A1 direction, the rotation shaft portion 25c is retained above the second straight guide portion 41c. The position of the rotation shaft portion 25c at this time is the same position as the position described above with reference to FIG. 13 (second position).

After that, when the large-diameter disk 100 is further conveyed in the arrow A1 direction, the large-diameter disk 100 is contacted with the disk contact portion 25a of the trigger lever 25 so as to press the trigger lever 25. Thereby, the trigger lever 25 is rotated in the arrow A10 direction about the rotation shaft portion 25c engaged with the axial hole 22g and placed above the second straight guide portion 41c. Thereby, the slide cam pressing portion 25b of the trigger lever 25 moves as described above with reference to FIGS. 14 to 16, so that the disk installment operation is performed.

Next, functions of the guide rib 41 and the twist spring 42 when the small-diameter disk 200 is inserted into the casing 300 will be described.

As described above with reference to FIG. 18, the small-diameter disk 200 inserted into the casing 300 is contacted with the positioning contact portions 24c, 24d of the centering member 24. At this time, the rotation shaft portion 25c of the trigger lever 25 is placed above the first straight guide portion 41a (first position) as shown in FIG. 39.

After that, when the small-diameter disk 200 is further conveyed in the arrow A1 direction, the centering member 24 is pressed by the small-diameter disk 200 so as to move in the arrow A1 direction. At this time, the rotation shaft portion 25c is engaged with the axial hole 22g (refer to FIGS. 9 and 10) so that the movement in the arrow A1 direction is regulated, and biased in the opposite direction to the arrow A11 direction by the twist spring 42. Thus, the rotation shaft portion slides along the first straight guide portion 41a.

After that, when the small-diameter disk 200 is further conveyed in the arrow A1 direction, as well as the case described above with reference to FIG. 19, the small-diameter disk 200 is contacted with the disk contact portion 25a of the trigger lever 25 so as to press the trigger lever 25. Thereby, the trigger lever 25 is rotated in the arrow A10 direction about the rotation shaft portion 25c engaged with the axial hole 22g and placed above the first straight guide portion 41a (first position). Thereby, the slide cam pressing portion 25b of the trigger lever 25 moves as described above with reference to FIGS. 20 to 21, so that the disk installment operation is performed. It is noted that in the disk conveyance and installment operations of the small-diameter disk 200, the rotation shaft portion 25c moves only above the first straight guide portion 41a relative to the guide rib 41.

According to the disk device of the second embodiment, by the guide rib 41 and the twist spring 42, the rotation shaft portion 25c of the trigger lever 25 is moved in accordance with the movement of the centering member 24 in the conveying direction. With this configuration, as well as the case of the first embodiment described above, the series of operations of detecting the conveyed disk having a different diameter, placing the disk at the replayable position in accordance with the diameter of the disk so that the center of the disk faces the turntable 13, and driving the disk installment mechanism can be performed by the three members of the trigger member 25, the centering member 24, and the slide cam member 16. Therefore, the number of parts can be further reduced.

Although the present invention has been fully described in connection with the preferred embodiments thereof with reference to the accompanying drawings, it is noted that various changes and modifications are apparent to those skilled in the art. Such changes and modifications are to be understood as included within the scope of the present invention as defined by the appended claims unless they depart therefrom.

The entire disclosure of Japanese Patent Application No. 2010-078336 filed on Mar. 30, 2010, including specification, claims, drawings, and summary are incorporated herein by reference in its entirety.

### INDUSTRIAL APPLICABILITY

The disk device according to the present invention is capable of further reducing the number of parts. Thus, the present invention is particularly useful to a disk device provided with a slot-in loading mechanism for loading a disk-shape recording medium such as a CD and a DVD into the device without using a tray.

1. A disk device, comprising:
a disk conveyance mechanism which conveys a disk having a different diameter to a replayable position;
a disk installment mechanism which installs the disk conveyed to the replayable position onto a turntable so as to bring the disk into a replayable clamping state;
a trigger member which is rotated by being contacted with and pressed by the disk conveyed by the disk conveyance mechanism;
a slide cam member which drives the disk installment mechanism by being pressed and moved by the rotated trigger member; and
a centering member which centers the disk so that the disk faces the turntable at the replayable position, wherein
the trigger member has a rotation shaft portion serving as a rotation center of the trigger member, a disk contact portion to be contacted with the disk, and a pressing portion for pressing the slide cam member, and
the centering member is provided movably in a disk conveying direction by being contacted with and pressed by the conveyed disk, and the centering member has a guide portion for moving the rotation shaft portion of the trigger member in accordance with movement in the disk conveying direction.

2. The disk device according to claim 1, wherein
the guide portion differentiates a position of the rotation shaft portion of the trigger member between a case where the disk is a small-diameter disk and a case where the disk is a large-diameter disk.

3. The disk device according to claim 1, wherein
the guide portion does not move the rotation shaft portion of the trigger member in a case where the disk is the small-diameter disk, and the guide portion moves the rotation shaft portion of the trigger member in a case where the disk is the large-diameter disk.

4. The disk device according to claim 1, wherein
the guide portion has a first straight guide portion provided in parallel to the conveying direction so as to retain the rotation shaft portion of the trigger member at a first position, a tilt guide portion provided in a crossing direction to the conveying direction so as to move the rotation shaft portion of the trigger member from the first position to a second position with respect to the conveying direction, and a second straight guide portion provided in parallel to the conveying direction so as to retain the rotation shaft portion of the trigger member at the second position.

5. The disk device according to claim 1, wherein
the centering member has a pair of large-diameter disk positioning contact portions to be contacted with a large-diameter disk so as to center the large-diameter disk, and a pair of small-diameter disk positioning contact portions to be contacted with a small-diameter disk so as to center the small-diameter disk.

6. The disk device according to claim 1, wherein
the slide cam member has a first engagement portion to be engaged with the pressing portion of the trigger member when the disk contact portion of the trigger member is contacted with a small-diameter disk serving as the disk, and a second engagement portion to be engaged with the pressing portion of the trigger member when the disk contact portion of the trigger member is contacted with a large-diameter disk serving as the disk.

7. The disk device according to claim 6, wherein
the slide cam member has a cam portion for connecting the first engagement portion and the second engagement portion, and
the cam portion guides movement of the pressing portion of the trigger member from the first engagement portion to the second engagement portion when the large-diameter disk serving as the disk is conveyed and the rotation shaft portion of the trigger member moves.
